(19) United States
(12) Patent Application Publication
(10) Pub. No.: US 2025/0088894 A1
(43) Pub. Date: Mar. 13, 2025

(54) DYNAMIC DOWNLINK TRAFFIC BUFFERING

(71) Applicant: Dell Products, L.P., Round Rock, TX (US)

(72) Inventor: Ali Esswie, Calgary (CA)

(21) Appl. No.: 18/466,554

(22) Filed: Sep. 13, 2023

(51) Int. Cl. H04W 28/02; H04W 28/06

(52) U.S. Cl. CPC H04W 28/0231; H04W 28/06

(57) ABSTRACT

A user equipment, which may comprise an extended reality processing unit, may transmit to a radio access network node a local storage capability indication. The node may receive from core network equipment, or from the user equipment, a request for stable information that changes infrequently. The node may transmit the stable information to the user equipment along with an indication to store the stable information at a local storage if the local storage capability indication indicates that the stable information is storable at the local storage. The node may receive another request for the same stable information and instead of transmitting the stable information to the user equipment again may instead transmit to the user equipment a stable information retrieval indication, responsive to which the user equipment may retrieve from the local storage the stable information and transmit the stable information to an extended reality appliance.

### BACKGROUND

The ‘New Radio’ (NR) terminology that is associated with fifth generation mobile wireless communication systems (“5G”) refers to technical aspects used in wireless radio access networks (“RAN”) that comprise several quality of service classes (QoS), including ultrareliable and low latency communications (“URLLC”), enhanced mobile broadband (“eMBB”), and massive machine type communication (“mMTC”). The URLLC QoS class is associated with a stringent latency requirement (e.g., low latency or low signal/message delay) and a high reliability of radio performance, while conventional eMBB use cases may be associated with high-capacity wireless communications, which may permit less stringent latency requirements (e.g., higher latency than URLLC) and less reliable radio performance as compared to URLLC. Performance requirements for mMTC may be lower than for eMBB use cases. Some use case applications involving mobile devices or mobile user equipment such as smart phones, wireless tablets, smart watches, and the like, may impose on a given RAN resource loads, or demands, that vary. A RAN node may activate a network energy saving mode to reduce power consumption.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In an example embodiment, a method may comprise facilitating, by a radio access network node, receiving, from a user equipment, a local storage capability indication indicative of a local storage capacity corresponding to a local storage associated with the user equipment. The method may further comprise facilitating, by the radio access network node, receiving a stable information indication indicative of stable information corresponding to the user equipment and analyzing, by the radio access network node with respect to the local storage capacity, the stable information to result in analyzed stable information. Based on the analyzed stable information being determined to be capable of being stored on the local storage, the method may further comprise facilitating, by the radio access network node, transmitting, to the user equipment, a stable information storage indication indicative to the user equipment to store the stable information to the local storage. The method may further comprise facilitating, by the radio access network node, receiving a stable information request indication indicative that the stable information is to be delivered to the user equipment and facilitating, by the radio access network node, transmitting, to the user equipment, a stable information retrieval indication indicative to the user equipment to retrieve the stable information from the local storage.

The stable information indication may be received from core network equipment. The stable information indication may be received from the user equipment.

In an embodiment, the method may further comprise facilitating, by the radio access network node, transmitting, to the user equipment, the stable information as stable information downlink traffic. The stable information storage indication may comprise a medium access control control element corresponding to the stable information downlink traffic.

In an embodiment, the method may further comprise facilitating, by the radio access network node, transmitting, to the user equipment, the stable information as stable information downlink traffic payload. The stable information storage indication may comprise a downlink control information message element corresponding to the stable information downlink traffic.

In an embodiment, the method may further comprise facilitating, by the radio access network node, transmitting, to the user equipment, a local storage flush indication indicative to the user equipment to remove the stable information from the local storage. The determining to transmit the local storage flush indication may be facilitated by the radio access network node based on a size of the stable information and a local size, indicated in the local storage capability indication, corresponding to the local storage. The determining to transmit the local storage flush indication may be facilitated by the radio access network node based on an age of the stable information in the local storage, or a length of time that the stable information has been stored in the local storage.

The stable information retrieval indication may be a first stable information retrieval indication, and the method may further comprise determining, by the radio access network node, that at least one transmission, facilitated by the radio access network node, of at least one subsequent stable information retrieval indication, subsequent to transmission of the first stable information retrieval indication, satisfies a stable information retrieval indication criterion, to result in a determined at least one subsequent stable information retrieval indication. Based on the at least one subsequent stable information retrieval indication satisfying the stable information retrieval indication criterion, the method may further comprise determining, by the radio access network node, to transmit the local storage flush indication. The determining to transmit the local storage flush indication may be facilitated by the radio access network node based on transmission of at least one stable information retrieval indication. The stable information may be partial stable information. The local storage flush indication may comprise a full local storage flush indication indicative to the user equipment to flush all stable information, that comprises the partial stable information, from the local storage.

In an embodiment, the method may further comprise determining, by the radio access network node, a channel condition metric corresponding to at least one channel condition parameter and analyzing, by the radio access network node, the channel condition metric with respect to a channel condition criterion, to result in an analyzed channel condition metric. An example of the at least one channel condition metric may be a measured amount of network channel congestion. The radio access network node may transmit the stable information storage indication to the user equipment based on the analyzed channel condition metric failing to satisfy the channel condition criterion. For example, the radio access network node may transmit the stable information storage indication to the user equipment if the analyzed channel condition metric indicates that radio channel between the radio access network node and the user equipment is congested and that reducing transmission from the radio access network node to the user equipment of stable information would increase spectral efficiency of network radio resources.

The channel condition metric may be a first channel condition metric. The analyzed channel condition metric may be an analyzed first channel condition metric. The method may further comprise determining, by the radio access network node, a second channel condition metric corresponding to the at least one channel condition parameter and analyzing, by the radio access network node, the second channel condition metric with respect to the channel condition criterion, to result in an analyzed second channel condition metric. Based on determining that the analyzed second channel condition metric satisfies the channel condition criterion being facilitated by the radio access network node, the method may further comprise facilitating, by the radio access network node, transmitting, to the user equipment, a local storage flush indication indicative to the user equipment to remove the stable information from the local storage.

In another example embodiment, a radio access network node may comprise a processor configured to transmit, to a user equipment, stable information associated with an environment corresponding to the user equipment, to result in transmitted stable information and to analyze, with respect to a stable information transmission criterion, the transmitted stable information to result in analyzed transmitted stable information. Based on the analyzed transmitted stable information satisfying the stable information transmission criterion, the processor may be further configured to transmit, to the user equipment, a stable information storage indication indicative to the user equipment to store the stable information to the local storage associated with the user equipment. The processor may be further configured to receive a stable information request indication indicative that the stable information is to be delivered to the user equipment and to transmit, to the user equipment, a stable information retrieval indication indicative to the user equipment to retrieve the stable information from the local storage.

In an embodiment, the processor may be further configured to transmit, to the user equipment, a local storage flush indication indicative to the user equipment to remove the stable information from the local storage.

The stable information transmission criterion may comprise a configured number of instances of transmission, by the radio access network node to the user equipment, of the stable information. The analyzed transmitted stable information may comprise an actual number of instances of transmission, by the radio access network node to the user equipment, of the stable information.

The stable information indicated by the stable information retrieval indication may comprise information corresponding to a downlink traffic flow associated with a communication session between the user equipment and the radio access network node.

In an embodiment, the communication session between the user equipment and the radio access network node may facilitate an extended reality (“XR”) service and the downlink traffic flow may correspond to the XR service.

In yet another example embodiment, a non-transitory machine-readable medium may comprise executable instructions that, when executed by a processor of a radio access network node, facilitate performance of operations, comprising transmitting, to a user equipment, a stable information storage indication indicative to the user equipment to store, to a local storage associated with the user equipment, stable information associated with an XR environment corresponding to the user equipment. The operations may further comprise receiving a downlink traffic payload indication indicative that the stable information is to be transmitted to the user equipment as downlink traffic payload of a downlink traffic flow associated with an XR communication session corresponding to the XR environment and transmitting, to the user equipment, a stable information retrieval indication indicative to the user equipment to retrieve the stable information from the local storage. The operations may further comprise avoiding transmitting the stable information as downlink traffic payload corresponding to the downlink traffic flow.

In an embodiment, the operations may further comprise transmitting, to the user equipment, a local storage flush indication indicative to the user equipment to remove the stable information from the local storage, wherein determining to transmit the local storage flush indication is facilitated by the radio access network node based on a size of the stable information and a local size, indicated in the local storage capability indication, corresponding to the local storage.

In an embodiment, the operations may further comprise transmitting, to the user equipment, a local storage flush indication indicative to the user equipment to remove the stable information from the local storage, wherein determining to transmit the local storage flush indication is facilitated by the radio access network node based on an age of the stable information in the local storage.

Another example method embodiment may comprise transmitting, by a user equipment comprising a processor to a radio access network node, a stable information request corresponding to a stable object associated with an extended reality (“XR”) session being facilitated by the user equipment. Responsive to transmitting a stable information request that requests the stable information as part of the XR session, the method may comprise receiving, from the radio access network node, a stable information retrieval indication indicative to the user equipment to retrieve the stable information from a local storage corresponding to the user equipment. Responsive to the stable information retrieval indication, the method may further comprise retrieving, by the user equipment from the local storage, the stable information to result in retrieved stable information. The method may further comprise avoiding, by the user equipment, receiving the stable information as downlink traffic payload of a downlink traffic flow associated with the XR session.

In an embodiment, the method may further comprise transmitting, to the radio access network node, a local storage capability indication, indicative of a storage characteristic corresponding to a local storage associated with the user equipment, usable by the radio access network node to determine to transmit, by the radio access network node to the user equipment, the stable information retrieval indication.

The storage characteristic may comprise at least one of: a capacity corresponding to the local storage, or an availability corresponding to the local storage. The local storage capability indication may be transmitted in at least one of: an uplink control channel message, or a radio resource control connection establishment message.

In an embodiment, the method may further comprise transmitting, by the user equipment to an XR appliance that is facilitating the XR session, the retrieved stable information. The retrieved stable information may be transmitted by the user equipment to the XR appliance via a sidelink communication link. The retrieved stable information may be transmitted by the user equipment to the XR appliance via a device-to-device communication link. The device-to-device communication link may comprise at least one of: a Wi-Fi communication link, a WiGig communication link, or a Bluetooth communication link.

In yet another embodiment, an extended reality (“XR”) processing unit may comprise a processor configured to receive, from an XR appliance, a stable information request comprising a request for stable information corresponding to a stable object associated with an XR session being facilitated by the XR processing unit, the XR appliance, and a radio access network node, to result in requested stable information. Responsive to receiving the stable information request, the processor may be configured to determine that the requested stable information is stored locally with respect to the XR processing unit to result in determined stored stable information and the processor may be configured to retrieve, from a local storage equipment corresponding to the XR processing unit, the determined stored stable information to result in retrieved stable information. Responsive to the stable information request, the processor may be further configured to provide the retrieved stable information to the XR appliance.

In an embodiment, the processor may be further configured to avoid receiving, from the radio access network node, the determined stored stable information as downlink traffic payload of a downlink traffic flow associated with the XR session.

In an embodiment, the processor may be further configured to transmit, to the radio access network node, a local storage capability indication, indicative of a local storage capacity corresponding to the local storage equipment and usable by the radio access network node to determine to instruct the XR processing unit to store the stable information to the local storage equipment.

In an embodiment, the stable information request may be a first stable information request, and the processor may be further configured to receive, from the XR appliance, a second stable information request comprising a request for the stable information corresponding to the stable object, wherein the second stable information request is received by the processor before the first stable information request is received by the processor. Responsive to receiving the second stable information request, the process may be further configured to transmit, to the radio access network node, a third stable information request comprising a request for the stable information. Responsive to transmitting the third stable information request, the processor may be further configured to receive, from the radio access network node, a stable information storage indication indicative to the XR processing unit to store the stable information to the local storage equipment. The stable information storage indication may be based on the local storage capability indication indicating that the local storage equipment is capable of storing the stable information. The processor may be further configured to store the stable information to the local storage equipment.

In an embodiment, the XR processing unit may comprise the local storage equipment. The local storage component may be separate from the processor.

In an embodiment, the processor may be further configured to receive, from the radio access network node, a local storage flush indication indicative to the XR processing unit to remove the stable information from the local storage equipment, and, responsive to the local storage flush indication, the processor may be configured to delete, from the local storage equipment, the stable information.

In an embodiment, the XR processing unit may be, or may be included in one of: a smartphone, a laptop computer, a router, or a tablet.

In another example embodiment, a non-transitory machine-readable medium may comprise executable instructions that, when executed by a processor of a user equipment, facilitate performance of operations, comprising receiving, a stable information request corresponding to a stable object associated with an extended reality (“XR”) session being facilitated by the user equipment and a radio access network node. The operations may further comprise determining that the stable information is stored on a local storage corresponding to the user equipment to result in determined stable information. Responsive to determining the determined stable information, the operations may further comprise retrieving the stable information from the local storage. The operations may comprise avoiding receiving, from the radio access network node, the stable information as downlink traffic payload of a downlink traffic flow associated with the XR session.

The determined stable information may comprise at least one protocol data unit, for example a packet or a group of packets, corresponding to a downlink traffic flow associated with the XR session.

In an embodiment, the operations may further comprise transmitting, to the radio access network node, a local storage capability indication, indicative of a capacity corresponding to the local storage and usable by the radio access network node to determine to instruct the XR processing unit to store the stable information to the local storage equipment.

In an embodiment, the operations may further comprise receiving, from the radio access network node, a local storage flush indication corresponding to the stable information, and responsive to the local storage flush indication, removing the stable information from the local storage.

In an embodiment, the operations may further comprise transmitting, to the radio access network node, an updated local storage capability indication, indicative of an updated capacity corresponding to the local storage and usable by the radio access network node to determine to instruct the XR processing unit to store new stable information to the local storage equipment.

### BRIEF DESCRIPTION OF THE DRAWINGS

FIG. 1 illustrates wireless communication system environment.

FIG. 2 illustrates an example virtual reality appliance.

FIG. 3 illustrates an example environment with an extended reality appliance tethered to a user equipment.

FIG. 4 illustrates a local storage capability indication indicative of a local storage capacity corresponding to a local storage associated with a user equipment being indicated to a radio access network node.

FIG. 5 illustrates stable information storage being indicated to a user equipment to store stable information to a local storage.

FIG. 6 illustrates an example of a core network component determining to indicate local storing of stable information.

FIG. 7 illustrates an example of local device determination to locally store stable information.

FIG. 8 illustrates an example of radio access network node determining to indicate local storing of stable information.

FIG. 9 illustrates an example of radio access network node indication of local forwarding of locally stored stable information.

FIG. 10 illustrates an example of local storage flushing.

FIG. 11 illustrates a timing diagram of an example embodiment of determining uplink jitter of a tethered user device and reporting uplink jitter to a radio access network node.

FIG. 12 illustrates a flow diagram of an example embodiment method of determining uplink jitter of a tethered user device and reporting uplink jitter to a radio access network node.

FIG. 13 illustrates a block diagram of an example method embodiment.

FIG. 14 illustrates a block diagram of an example radio access network node.

FIG. 15 illustrates a block diagram of an example non-transitory machine-readable medium embodiment.

FIG. 16 illustrates a block diagram of an example method embodiment.

FIG. 17 illustrates a block diagram of an example extended reality processing unit.

FIG. 18 illustrates a block diagram of an example non-transitory machine-readable medium embodiment.

FIG. 19 illustrates an example computer environment.

FIG. 20 illustrates a block diagram of an example wireless user equipment.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. In yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As an example use case that illustrates example embodiments disclosed herein, Virtual Reality (“VR”) applications and VR variants, (e.g., mixed and augmented reality) may at some time perform best when using NR radio resources associated with URLLC while at other times lower performance levels may suffice. A virtual reality smart glass device may consume NR radio resources at a given broadband data rate having more stringent radio latency and reliability criteria to provide a satisfactory end-user experience.

5G systems should support ‘extended reality’ (“XR”) services. XR service may be referred to as anything reality services. XR services may comprise VR applications, which are widely adopted XR applications that provide an immersive environment which can stimulate the senses of an end user such that he, or she, may be ‘tricked’ into the feeling of being within a different environment than he, or she, is actually in. XR services may comprise Augmented Reality (‘AR’) applications that may enhance a real-world environment by providing additional virtual world elements via a user's senses that focus on real-world elements in the user's actual surrounding environment. XR services may comprise Mixed reality cases (“MR”) applications that help merge, or bring together, virtual and real worlds such that an end-user of XR services interacts with elements of his, or her, real environment and virtual environment simultaneously.

Different XR use cases may be associated with certain radio performance targets. Common to XR cases, and unlike URLLC or eMBB, high-capacity links with stringent radio and reliability levels are typically needed for a satisfactory end user experience. For instance, compared to a 5 Mbps URLLC link with a 1 ms radio budget, some XR applications need 100 Mbps links with a couple of milliseconds of allowed radio latency. Thus, 5G radio design and associated procedures may be adapted to the new XR QoS class and associated performance targets.

An XR service may be facilitated by traffic having certain characteristics associated with the XR service. For example, XR traffic may typically be periodic with time-varying packet size and packet arrival rate. In addition, different packet traffic flows of a single XR communication session may affect an end user's experience differently. For instance, a smart glass that is streaming 180-degree high-resolution frames may use a large percentage of a broadband service's capacity for fulfilling a user experience. However, frames that are to be presented to a user's pose direction (e.g., front direction) are the most vital for an end user's satisfactory user experience while frames to be presented to a user's periphery vision have less of an impact on a user's experience and thus may be associated with a lower QoS requirement for transport of traffic packets as compared to a QoS requirement for transporting the pose-direction traffic flow. Therefore, flow differentiation that prioritizes some flows, or some packets, of a XR session over other flows or packets may facilitate efficient use of a communication system's capacity to deliver the traffic. Furthermore, XR capable devices (e.g., smart glasses, projection wearables, etc.) may be more power-limited than conventional mobile handsets due to the limited form factor of the devices. Thus, techniques to maximize power saving operation at an XR capable device is desirable. Accordingly, a user equipment device accessing XR services, or traffic flows of an XR session, may be associated with certain QoS parameter criterion/criteria to satisfy performance targets of the XR service. Measured traffic values, or metrics, may correspond to a QoS, or analyzed with respect to, parameter criterion/criteria, such as, for example, a data rate, an end-to-end latency, or a reliability.

High-capacity-demanding services, such as virtual reality applications, may present performance challenges to even 5G NR capabilities. Thus, even though 5G NR systems may facilitate and support higher performance capabilities, the radio interface should nevertheless be optimized to support extreme high capacity and low latency requirements of XR applications and XR data traffic.

Multi-modal XR applications may integrate different technologies to offer a versatile and comprehensive user experience. For example, a multi-modal XR application might use VR to immerse users in a virtual training environment and then seamlessly switch to AR or MR to provide real-time feedback or overlay instructional information corresponding to physical objects that may appear in an environment viewed by an XR user. Such feedback or instructional information may relate to stationary objects or may be information that does not change frequently and may be referred to as stable information.

An advantage of multi-modal XR applications is the adaptability to facilitate different contexts and different user preferences. An XR application can provide varying levels of immersion and interaction, allowing users to choose the most suitable mode of engagement based on the user's needs or the specific task at hand. Additionally, multi-modal XR can enable collaborative experiences, allowing users in different physical locations to interact within the same virtual space.

Uses of multi-modal XR applications extend beyond entertainment and gaming, with widespread adoption in fields such as healthcare, education, engineering, and marketing. Medical practitioners can use multi-modal XR applications to simulate complex surgeries, educators can create interactive and immersive learning experiences, and architects can visualize and modify building designs in real-time.

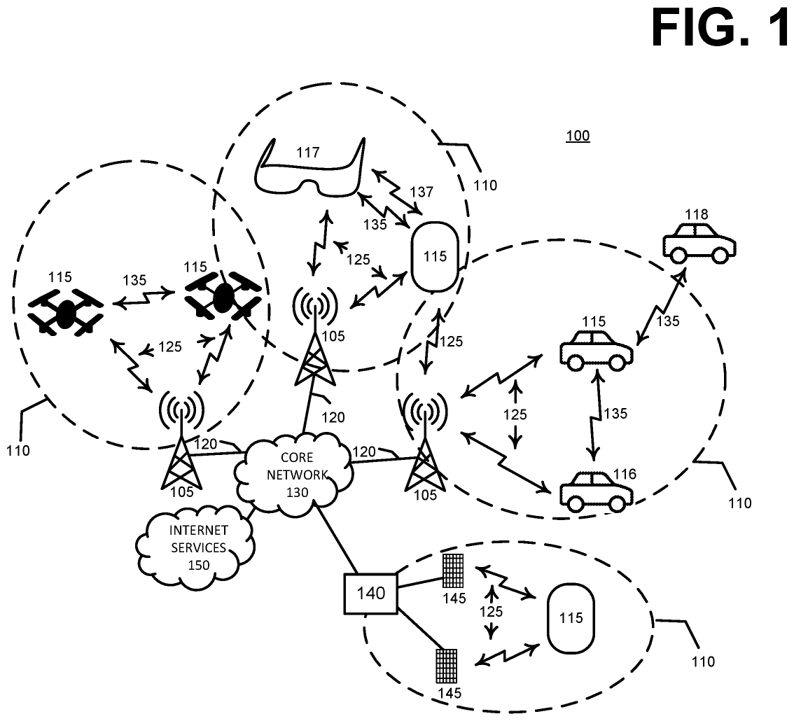

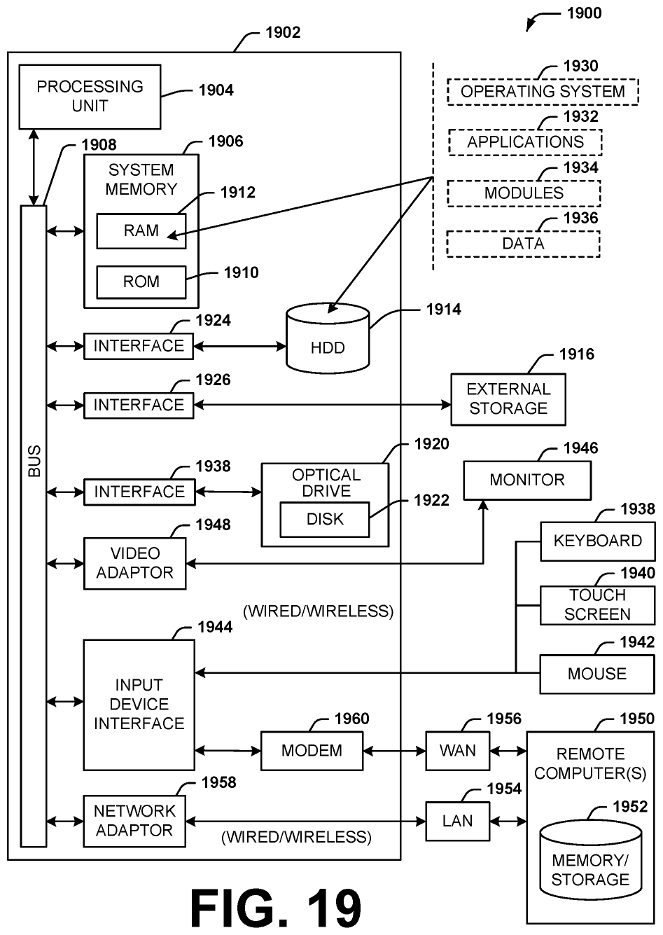

Turning now to the figures, FIG. 1 illustrates an example of a wireless communication system 100 that supports blind decoding of PDCCH candidates or search spaces in accordance with one or more example embodiments of the present disclosure. The wireless communication system 100 may include one or more base stations 105, one or more user equipment (“UE”) devices 115, and core network 130. In some examples, the wireless communication system 100 may comprise a long-range wireless communication network, that comprises, for example, a Long-Term Evolution (LTE) network, an LTE-Advanced (LTE-A) network, an LTE-A Pro network, or a New Radio (NR) network. In some examples, the wireless communication system 100 may support enhanced broadband communications, ultra-reliable (e.g., mission critical) communications, low latency communications, communications with low-cost and low-complexity devices, or any combination thereof. As shown in the figure, examples of UEs 115 may include smart phones, laptop computers, tablet computers, automobiles or other vehicles, or drones or other aircraft. Another example of a UE may be a virtual reality/extended reality appliance 117, such as smart glasses, a virtual reality headset, an augmented reality headset, and other similar devices that may provide images, video, audio, touch sensation, taste, or smell sensation to a wearer. A UE, such as XR appliance 117, may transmit or receive wireless signals with a RAN base station 105 via a long-range wireless link 125, or the UE/XR appliance may receive or transmit wireless signals via a short-range wireless link 137, which may comprise a wireless link with a UE device 115, such as a Bluetooth link, a Wi-Fi link, and the like. A UE, such as appliance 117, may simultaneously communicate via multiple wireless links, such as over a link 125 with a base station 105 and over a short-range wireless link. XR appliance 117 may also communicate with a wireless UE via a cable, or other wired connection. An XR appliance 117 may offload processing functionality or functionality related to communicating with a RAN, to a user equipment 115, which may be referred to as an intermediate user equipment or an XR processing unit. An XR processing unit or a RAN, or a component thereof, may be implemented by one or more computer components that may be described in reference to FIG. 19.

Continuing with discussion of FIG. 1, base stations 105, which may be referred to as radio access network nodes or cells, may be dispersed throughout a geographic area to form the wireless communication system 100 and may be devices in different forms or having different capabilities. The base stations 105 and the UEs 115 may wirelessly communicate via one or more communication links 125. Each base station 105 may provide a coverage area 110 over which UEs 115 and the base station 105 may establish one or more communication links 125. Coverage area 110 may be an example of a geographic area over which a base station 105 and a UE 115 may support the communication of signals according to one or more radio access technologies.

UEs 115 may be dispersed throughout a coverage area 110 of the wireless communication system 100, and each UE 115 may be stationary, or mobile, or both at different times. UEs 115 may be devices in different forms or having different capabilities. Some example UEs 115 are illustrated in FIG. 1. UEs 115 described herein may be able to communicate with various types of devices, such as other UEs 115, base stations 105, or network equipment (e.g., core network nodes, relay devices, integrated access and backhaul (IAB) nodes, or other network equipment), as shown in FIG. 1.

Base stations 105 may communicate with the core network 130, or with one another, or both. For example, base stations 105 may interface with core network 130 through one or more backhaul links 120 (e.g., via an S1, N2, N3, or other interface). Base stations 105 may communicate with one another over the backhaul links 120 (e.g., via an X2, Xn, or other interface) either directly (e.g., directly between base stations 105), or indirectly (e.g., via core network 130), or both. In some examples, backhaul links 120 may comprise one or more wireless links.

One or more of base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a bNodeB or gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, a personal computer, or a router. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or smart meters, among other examples.

UEs 115 may be able to communicate with various types of devices, such as other UEs 115 that may sometimes act as relays as well as base stations 105 and the network equipment including macro eNBs or gNBs, small cell eNBs or gNBs, or relay base stations, among other examples, as shown in FIG. 1.

UEs 115 and base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Wireless communication system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by UEs 115. A carrier may be operated in a standalone mode where initial acquisition and connection may be conducted by UEs 115 via the carrier, or the carrier may be operated in a non-standalone mode where a connection is anchored using a different carrier (e.g., of the same or a different radio access technology).

Communication links 125 shown in wireless communication system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications e.g., in a TDD mode).

A carrier may be associated with a particular bandwidth of the radio frequency spectrum, and in some examples the carrier bandwidth may be referred to as a “system bandwidth” of the carrier or the wireless communication system 100. For example, the carrier bandwidth may be one of a number of determined bandwidths for carriers of a particular radio access technology (e.g., 1.4, 3, 5, 10, 15, 20, 40, or 80 megahertz (MHZ)). Devices of the wireless communication system 100 (e.g., the base stations 105, the UEs 115, or both) may have hardware configurations that support communications over a particular carrier bandwidth or may be configurable to support communications over one of a set of carrier bandwidths. In some examples, the wireless communication system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE. A wireless communications resource may refer to a combination of a radio frequency spectrum resource, a time resource (e.g., a search space), or a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for a UE 115 may be restricted to one or more active BWPs.

The time intervals for base stations 105 or UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods e.g., depending on the length of the cyclic prefix prepended to each symbol period). In some wireless communication systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communication system 100 and may be referred to as a transmission time interval (TTI). In some examples, the TTI duration (e.g., the number of symbol periods in a TTI) may be variable. Additionally, or alternatively, the smallest scheduling unit of the wireless communication system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of UEs 115. For example, one or more of UEs 115 may monitor or search control regions, or spaces, for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115. Other search spaces and configurations for monitoring and decoding them are disclosed herein that are novel and not conventional.

A base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of a base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., UEs 115 in a closed subscriber group (CSG), UEs 115 associated with users in a home or office). A base station 105 may support one or multiple cells and may also support communications over the one or more cells using one component carrier, or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communication system 100 may include, for example, a heterogeneous network in which different types of the base stations 105 provide coverage for various geographic coverage areas 110 using the same or different radio access technologies.

The wireless communication system 100 may support synchronous or asynchronous operation. For synchronous operation, the base stations 105 may have similar frame timings, and transmissions from different base stations 105 may be approximately aligned in time. For asynchronous operation, base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communication system 100 may be configured to support ultra-reliable communications or low-latency communications, or various combinations thereof. For example, the wireless communication system 100 may be configured to support ultra-reliable low-latency communications (URLLC) or mission critical communications. UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). Communication link 135 may comprise a sidelink communication link. One or more UEs 115 utilizing D2D communications, such as sidelink communication, may be within the geographic coverage area 110 of a base station 105. Other UEs 115 in such a group may be outside the geographic coverage area 110 of a base station 105 or be otherwise unable to receive transmissions from a base station 105. In some examples, groups of UEs 115 communicating via D2D communications may utilize a one-to-many (1:M) system in which a UE transmits to every other UE in the group. In some examples, a base station 105 facilitates the scheduling of resources for D2D communications. In other cases, D2D communications are carried out between UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more RAN network nodes (e.g., base stations 105) using vehicle-to-network (V2N) communications, or with both. In FIG. 1, vehicle UE 116 is shown inside a RAN coverage area and vehicle UE 118 is shown outside the coverage area of the same RAN. Vehicle UE 115 wirelessly connected to the RAN may be a sidelink relay to in-RAN-coverage-range vehicle UE 116 or to out-of-RAN-coverage-range vehicle UE 118.

The core network 130 may provide user authentication, access authorization, tracking, Internet Protocol (IP) connectivity, and other access, routing, or mobility functions. Core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for UEs 115 that are served by the base stations 105 associated with core network 130. User IP packets may be transferred through the user plane entity, which may provide IP address allocation as well as other functions. The user plane entity may be connected to IP services 150 for one or more network operators. IP services 150 may comprise access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices e.g., radio heads and ANCs) or consolidated into a single network device (e.g., a base station 105).

The wireless communication system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHZ.

The wireless communication system 100 may also operate in a super high frequency (SHF) region using frequency bands from 3 GHZ to 30 GHZ, also known as the centimeter band, or in an extremely high frequency (EHF) region of the spectrum (e.g., from 30 GHz to 300 GHz), also known as the millimeter band. In some examples, the wireless communication system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communication system 100 may utilize both licensed and unlicensed radio frequency spectrum bands. For example, the wireless communication system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as base stations 105 and UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Base stations 105 or UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, a base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by a base station 105 in different directions and may report to the base station an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). A UE 115 may report feedback that indicates precoding weights for one or more beam directions, and the feedback may correspond to a configured number of beams across a system bandwidth or one or more sub-bands. A base station 105 may transmit a reference signal (e.g., a cell-specific reference signal (CRS), a channel state information reference signal (CSI-RS)), which may be precoded or unprecoded. A UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communication system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

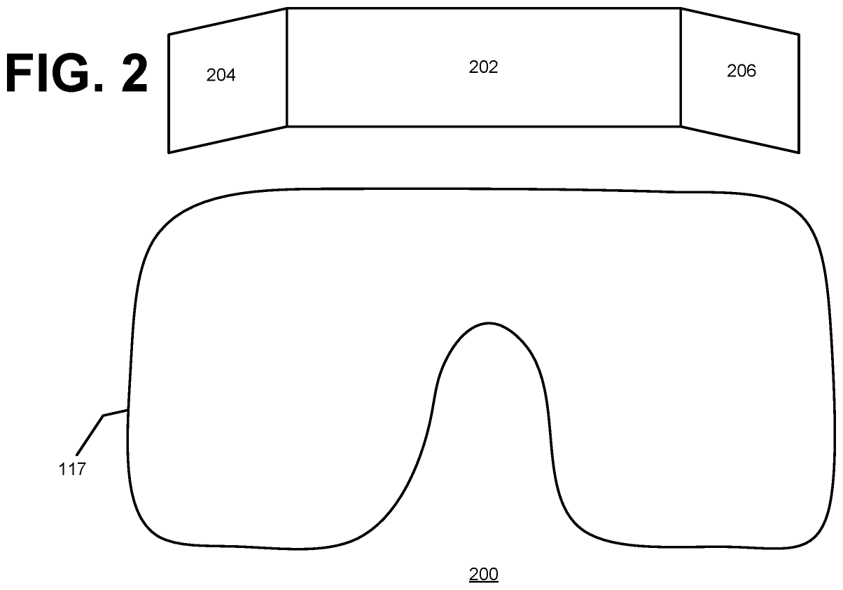

Turning now to FIG. 2, the figure illustrates a virtual reality (“VR”) application system 200. In system 200, wearable VR appliance 117 is shown from a wearer's, or viewer's, perspective. VR appliance 117 may comprise a center, or pose, visual display portion 202, a left visual display portion 204 and a right visual display portion 206, that may be used to display main visual information, left peripheral visual information, and right peripheral visual information, respectively. As shown in the figure, the portions 202, 204, and 206 are delineated by distinct lines, but it will be appreciated that hardware or software may facilitate gradual transition from main and peripheral information display.

As discussed above, different XR use cases may require different corresponding radio performance. Typically, for XR use cases but unlike for URLLC or eMBB use cases, high-capacity radio links that carry XR data traffic (e.g., data flows that comprise visual information) with stringent radio levels (e.g., latency) and reliability levels are required for a reasonable end user experience. For example, compared to a 5 Mbps URLLC link with a 1 ms radio latency budget, some XR applications require 100 Mbps links with about 2 mS allowed radio latency.

From research, several characteristics have been determined that for XR data traffic: (1) XR traffic characteristics are typically periodic with time-varying packet size and packet arrival rate; (2) XR capable devices may be more power-limited than conventional mobile handsets, (e.g., smart glasses, projection wearables, etc.) due to the limited form factor of the devices; (3) multiple data packet flows corresponding to different visual information of a given XR session are not perceived by a user as having the same impact on the end user experience.

Thus, in addition to needing XR-specific power use efficiency, smart glasses, such as wearable appliance 117, streaming 180-degree high-resolution frames requires broadband capacity for providing an optimum user experience. However, it has been determined that data corresponding to the frames that carry main, or center visual information (i.e., the pose or front direction) are the most vital for end user satisfaction, while the frames corresponding to peripheral visual information have a lesser impact on a user's experience. Therefore, accepting higher latency for less important traffic flows so that resources that would otherwise be allocated to the less important traffic flows can be used for traffic flows corresponding to more important traffic, or to devices that carry the more important traffic, may be used to optimize overall capacity and performance of a wireless communication system, such as a 5-G communication system using NR techniques, method, systems, or devices. For example, a wireless data traffic flow carrying visual information for display on center, or pose, visual display portion 202 may be prioritized higher than a wireless data traffic flow carrying visual information for left visual display portion 204 or for right visual display portion 206.

The performance of a communication network in providing an XR service may be at least partially determined according to satisfaction of a user of the XR services. Each XR-service-using user device may be associated with certain QoS metrics to satisfy the performance targets of the user's service, in terms of perceived data rate, end-to-end latency, and reliability.

A 5G NR radio system typically comprises a physical downlink control channel (“PDCCH”), which may be used to deliver downlink and uplink control information to cellular devices. The 5G control channel may facilitate operation according to requirements of URLLC and eMBB use cases and may facilitate an efficient coexistence between such different QoS classes.

As diverse XR services, including VR, AR, and MR proliferate, radio optimization techniques to facilitate the very high network capacity that the applications require are desirable. Such requirements may be the result of increases in streaming of ultra-high-capacity video content, which may facilitate immersive XR user experiences, that may lead to an enormous amount of traffic corresponding to an XR session being delivered with an ultra-high capacity and low latency budget. Such large amounts of traffic coupled with stringent capacity and latency budget criteria may result in a degraded overall network spectral efficiency due to a RAN node supporting the stringent XR requirements only for a small number of user equipment while traffic to other user equipment may be blocked or throttled.

It has been observed that a traffic scheduling characteristic corresponding to many emerging indoor XR use cases is that a significant amount of traffic is semi-static, or stable, in nature. Semi-static, or stable, traffic may comprise, or carry, information that corresponds to virtual objects. The information corresponding to the virtual objects may be dynamically downloaded/streamed from a RAN node to an XR device and may be tied to the real, or actual, environment in which an XR appliance is being used. An XR device may be used in an almost static, or semi-static, environment with a slow variation rate, for example indoor XR deployment, which is the most typical XR use case. Thus, a RAN node may dynamically schedule the same XR traffic sets, representing, or corresponding to, virtual objects, for example, to facilitate repeated viewing by a user on an XR appliance, multiple times during an XR session, thus degrading overall cell spectral efficiency. The virtual objects that are static or semi-static may be referred to as stable objects and information corresponding to a stable object that may be scheduled by a RAN node for transmission directed to an XR appliance may be referred to as stable information.

Embodiments disclosed herein include a novel XR device type with a dynamically configurable local traffic storage capability. According to embodiments disclosed herein, during an XR session an XR traffic portion, or ‘chunk,’ may be identified to be semi-static (e.g., stable) with an expectation that the stable XR traffic portion may be viewed multiple times by an XR appliance user. Thus, there is an expectation that the stable information will be delivered to the XR appliance multiple times during the XR session. For example, each time the user of the XR appliance points a pose portion of the XR appliance at a real object in a room, download and delivery to the XR appliance of stable information corresponding to the real object in the room may be triggered. In an embodiment, instead of download via long range wireless links, such as links 125 shown and described in reference to FIG. 1, stable information may be downloaded once via the long-range wireless links and stored locally with respect to the XR device. Thus, instead of a RAN node storing the stable information and delivering the stable information via long range wireless links every time delivery to an XR appliance is triggered, the RAN node may instead merely transmit an indication that the stable information is to be retrieved from a local storage and delivered to a viewing portion of the XR appliance, such as pose portion 202, or peripheral portions 204 or 206, of appliance 117 shown in FIG. 2. Accordingly, the RAN node may avoid repeated scheduling instants corresponding to the stable information/stable traffic, and scheduling overhead and transmissions of the same XR traffic chunks may be avoided, thus leading to improvement in overall wireless network capacity corresponding to the RAN node.

Instead of traffic being transmitted directly from a RAN node to an XR appliance, the RAN node may transmit, via long range wireless links 125, traffic to an intermediate user equipment device 115, which may be referred to as an XR processing unit. In an embodiment, the XR processing unit may dynamically indicate local storage capabilities corresponding to a buffer, or other memory portion, that is to be used to store stable information corresponding to a stable object. The locally stored stable object information may comprise certain packets, or packet groups, that may be stored, or buffered, to facilitate future scheduling requests instead of to facilitate an immediate, or current, scheduling request and support of an XR session. In an embodiment, an adaptive packet flushing scheme may be implemented to facilitate a RAN node offloading the local traffic storage processing and energy overhead from an XR processing unit when long range wireless network radio congestion conditions are relaxed, if a determination is made by the RAN node that multiple scheduling and transmission instants of the same stable information traffic chunks can be performed without impacting user equipment other than the XR processing unit. Such taking back of scheduling and processing of stable information may be used to facilitate prolonging battery life, or battery charge, corresponding to an XR processing unit, wherein locally storing and forwarding of stable information by the XR processing unit may be adopted when needed to alleviate wireless network traffic congestion.

As described above, traffic characteristics of XR applications may be static, or semi-static, in nature, and may be referred to herein as stable insofar as information conveyed by the traffic is stable (e.g., the information changes infrequency, if at all). Thus, according to conventional techniques, the same chunk of stable XR-related traffic may be scheduled by a RAN node multiple times within a short period of time without the traffic, and the information conveyed thereby, actually changing. For example, for an educational XR use case, where a static virtual object pops up on a viewing portion of a user's XR appliance, showing certain virtual information related to a real object to which a user of the XR appliance has pointed or clicked, according to conventional techniques, a traffic flow(s), representing stable information related to such static virtual object(s), is/are dynamically scheduled for transmission by a RAN node (with dynamic control channel information delivery) for each pointing action or clicking action performed by the user or XR appliance. In another example, within indoor XR deployments (e.g., within a living room or a classroom), real objects of the surrounding environment are typically static or semi-static (e.g., stable), thus, related virtual object information to be downloaded are static or semi-static too (e.g., stable information). Scheduling and transmission of stable information multiple times to the same user equipment for the same XR session, and the network overhead, dynamic scheduling, and dynamic content delivery of such stable traffic multiple times may be unnecessary and may lead to severe degradation of overall wireless communication network spectral efficiency due to the RAN node scheduling and transmitting the same content (representing stable information corresponding to the same XR virtual objects) repeatedly over the radio interface.

Such repeated scheduling and transmitting of the same stable information results from XR session content originating at, or being stored by, a RAN node or a backend XR content server according to conventional techniques. Thus, according to embodiments disclosed herein, dynamic content storage, forwarding, and flushing are enabled at an XR processing unit. An XR processing unit may comprise a smartphone, laptop, tablet, or router, or a user equipment that may be optimized for XR content processing and that comprises a modem or processor to facilitate wireless communication via a link 125 to a RAN node 105. The XR processing unit, or other type of user equipment, may have a storage capacity, for example a random access memory or a processor register, which has more capacity than a conventional scheduling buffer of a typical smartphone, to facilitate local storage of traffic chunks, corresponding to stable information, that are static or semi-static, thus avoiding repeated scheduling and delivery of the same traffic/content and thus leading to improved overall RAN capacity and efficiency.

### Dynamic Device Downlink Traffic Buffering

Embodiments disclosed herein may be implemented in different XR deployment setups. For example, an XR end-device/appliance, (e.g., glasses or a helmet) may be equipped with a 5G RF chain, storage, and scheduling buffers. In another example, an XR appliance may only facilitate viewing XR traffic and processing and local traffic storage of traffic, such as stable traffic/stable information, may be facilitated by an XR processing unit, which may be housed in a ‘box’ proximate the XR appliance (e.g., within a short-range wireless communication link range such as a sidelink interface range, a Bluetooth range, a Wi-Fi range, a WiGig range, and the like).

Accordingly, embodiments disclosed herein may comprise an XR appliance device, and/or associated processing unit, compiling and transmitting to a serving RAN node XR capability information during XR session connection establishment with the RAN node. The XR appliance/processing unit may indicate capability information via a local storage capability indication indicative of a local storage capacity corresponding to a local storage associated with the XR appliance/processing unit user equipment. The local storage capability indication may be indicative of the local storage being enabled for local storage or indicative of a maximum available size of a storage buffer of the local storage. The indicated storage capability may facilitate differentiation by the RAN node between XR-related devices with local traffic storage capability (and a corresponding capacity, or amount of storage available) and XR-related devices without such capability.

The RAN node may dynamically configure an XR device to locally store all, or part of, each scheduled traffic flow based on evaluation, by the RAN node, of information corresponding to traffic flows to determined one or more traffic flows that may require multiple repeated scheduling instants because the one or more traffic flows may comprise stable information related to static, or semi-static, XR-session-environment objects. By configuring an XR device to locally store stable information instead of retransmitting the stable information each time a request for the stable information is generated by an XR appliance, a RAN node may increase network spectral efficiency. Information used by the RAN to determine to configure and instruct an XR processing unit to store stable information may be obtained by the RAN node via an indication from core network equipment (e.g., a UPF or an AMF), indicating that that payload is semi-static or static (e.g., stable) and can be locally stored by an XR device for expected repeated future deliveries. The indication received from the core network equipment may be referred to as a stable information indication. A stable information indication may be indicative of stable information corresponding to the XR user equipment that is facilitating an XR session corresponding to the stable information. (A backend XR server may have advanced rendering capabilities used to determine traffic/information to be directed to an XR appliance and thus may be capable of determining that certain information changes infrequently.) Information used by a RAN node to determine to configure and instruct an XR processing unit to store stable information may be obtained by the RAN node via an uplink indication transmitted by an XR appliance/device or an XR processing unit. The uplink indication may comprise a request for the XR appliance/device or the XR processing unit to locally store indicated packet flows, or stable information corresponding thereto. (XR appliances or XR processing units may comprise advanced rendering capabilities).

Upon receiving a dynamic local storage indication from the RAN node, an XR device and/or associated processing unit may duplicate indicated traffic ‘chunks’ corresponding to stable information (e.g., traffic may be indicated in terms of packets' sequence numbers or packet group sequence numbers). The XR processing unit may store a first duplicate/copy of stable information in a decoding/scheduling buffer and a second duplicate/copy in a local storage buffer for future local payload delivery. Upon a new request (e.g., after the copy in the decoding/scheduling buffer has been delivered for viewing by a user) received by the XR processing unit requesting new payload viewing, the XR processing unit may determine whether the requested stable information is present in the local storage buffer. If requested stable information is stored in the local storage buffer, the XR processing unit may not request scheduling of the stable information from the RAN node. Instead, the XR processing unit may duplicate the requested stable information from the local storage buffer towards the decoding/scheduling/forwarding buffer and proceed with immediate packet decoding and/or forwarding to the end XR glass/device, without the RAN node involvement. It will be appreciated that if the stable information is stored in the local storage buffer in a format with packet header or other transmission protocol information having been stripped away, the stable information may be transmitted from the local storage buffer without further decoding. This is applicable for the case wherein the XR device processing unit manages control and data channels with respect to the RAN node.

In another embodiment, wherein the XR appliance (e.g., appliance 117 shown in FIG. 1) manages only a direct control channel with respect to the RAN node while a corresponding in-box processing unit (e.g., an XR processing unit 115) manages the data channel, the XR processing unit may receive a local forwarding indication from the RAN node indicating one or more packet or packet groups which are to be locally forwarded to the XR appliance from a local storage buffer of the XR processing unit. In an embodiment, to relax the storage load on the XR device or XR processing unit, the RAN node may send a local storage flush indication indicative of one or more of the locally stored packets or packet groups to be dynamically scheduled for transmission by the RAN node according to conventional techniques. At the XR device (XR processing unit 115 or appliance 117 if equipped with a local storage buffer with capacity to store stable information), upon receiving a local storage flush indication the XR appliance or XR processing unit may flush and delete indicated packets from the local storage buffer. Thus, the RAN node may maintain control and enforcement of which XR session packets stay locally stored at the XR device itself and which XR session packets to be dynamically scheduled for transmission from the RAN node depending on the state of the RAN congestion and depending on XR appliance or processing unit capability and energy consumption conditions.

Embodiments disclosed herein facilitate local traffic storage and forwarding by the same user equipment. A RAN node may receive a scheduling request for downlink traffic, but instead of scheduling and granting a resource for delivery of the downlink traffic may transmit a stable information retrieval indication indicative to the user equipment to retrieve the stable information from a local storage. The user equipment may decode the locally retrieved stable information. The user equipment may forward the locally retrieved, or decoded, stable information to an XR appliance.

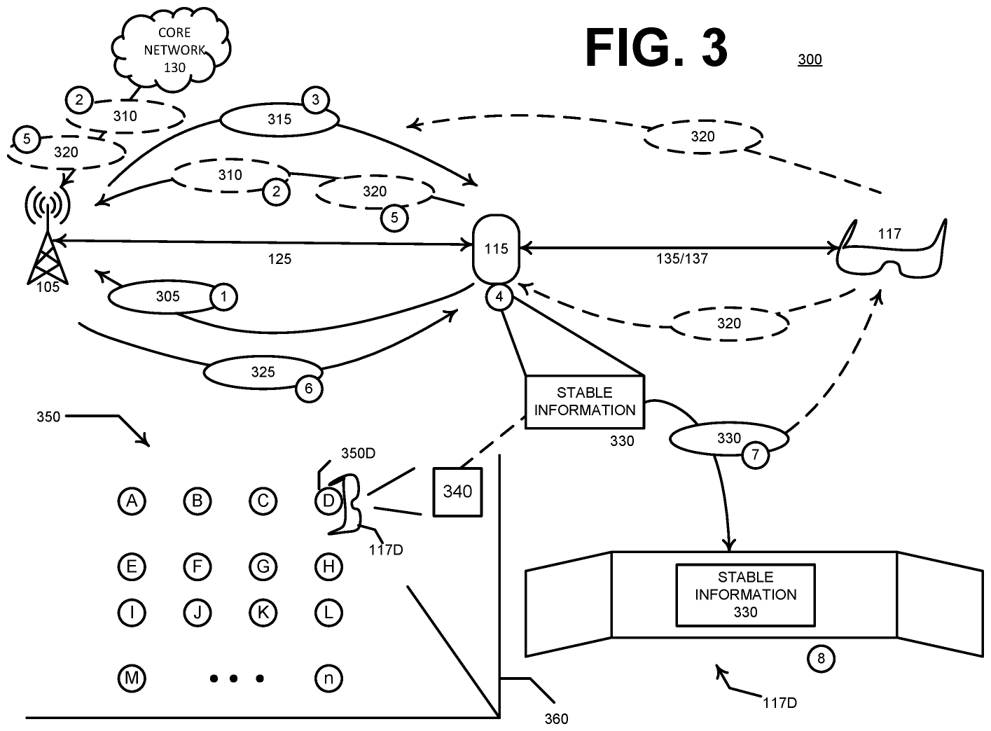

Turning now to FIG. 3, the figure illustrates an example environment 300 with an anything reality/extended reality appliance 117 tethered to a user equipment 115. In the embodiment shown in FIG. 3, XR processing unit/UE 115 is associated with the end XR device/appliance 117. In an embodiment, processing unit 115 may perform XR traffic payload processing and novel local traffic storage functionality as described herein. In another embodiment, appliance 117 may perform novel local traffic storage functionality as described herein. At act 1, XR processing unit 115 may compile and transmit a local XR traffic storage capability information indication 305 towards RAN node 105 during XR session establishment. Indication 305 may be referred to as a local storage capability indication and may be indicative of a local storage capacity corresponding to a local storage associated with XR processing user equipment 115. At act 2, the radio access network node may receive a stable information indication 310. The stable information indication may be received from equipment of core network 130 or from user equipment 115, which may be an XR processing unit. Thus, two stable information indications 310 are shown with dashed lines to represent that either the user equipment or core network could be the source of the stable information indication with respect to the radio access network node 105. A stable information indication 310 may comprise a request for information that may be deemed stable, or that infrequently changes. For example, one of multiple students 350 in training room 360, for example student 350D, wearing XR appliance 117 may perform a trigger action, for example, gazing at, looking at, pointing at, or clicking at object 340 in the training room. Performing the trigger action using appliance 117 with respect to object 340 may cause transmission of a stable information indication 310, which may comprise a request for stable information 330 corresponding to the indication transmitted at act 2.

Radio access network node 105 may analyze stable information indication 310, and the amount or size of information indicated in the stable information indication, with respect to a size or capacity corresponding to a local storage associated with user equipment 115, which capacity may be indicated in storage capability information indication 305, to result in analyzed stable information, which may comprise stable information 330 being determined to be capable of being stored at the local storage associated with the user equipment. Based on the analyzed stable information being determined to be capable of being stored on the local storage, radio access network node 105 may transmit, to user equipment 115 at act 3, stable information storage indication 315, which may be indicative to user equipment 115 to store stable information 330, indicated by indication 310 and corresponding to object 340, to a local storage at, coupled to, of corresponding to user equipment 115.

At act 4, user equipment 115 may store stable information 330 to a local storage buffer and also to a decoding buffer for transmission to appliance 117. At act 5, radio access network node 105 may receive a request for stable information 320. Request 320 may be transmitted by user equipment 115 or may be received from core network 130. The transmitting of request 320 may be based on user 350D performing a trigger action, for example gazing at object 340, subsequent to the action that triggered the transmitting of stable indication 310. In an embodiment, appliance 117 may generate request for stable information 320 and transmit the request for stable information to user equipment 115. Accordingly, request 320 is shown in dashed lines in FIG. 3 to indicate that even though a triggering action by user 350D with respect to object 340 may cause user equipment 115 to request stable information 330 via request for stable information 320, a component, or equipment, of core network 130 or appliance 117 may determine to generate and transmit to user equipment 115 a request for stable information 320. It will be appreciated that if appliance 117 comprises local storage functionality and other functionality of user equipment 115, the appliance may transmit request for stable information 320 to RAN node 105. At act 6, responsive to receiving requests for stable information 320, radio access network node 105 may transmit to user equipment 115 (or to appliance 117 if the appliance is equipped with local storage capability) stable information retrieval indication 325. Stable information retrieval indication 325 may be indicative to user equipment 115/appliance 117 to retrieve stable information 330 that was stored to the buffer at act 4. Responsive to receiving stable information retrieval indication 325, user equipment 115/appliance 117 may retrieve stable information 330 from a local storage buffer and forward the stable information to XR appliance 117D at act 7. At act 8, XR appliance 117D may display stable information 330 for viewing by user 350D.

Thus, XR processing unit 115 (or XR appliance 117 if the appliance includes user equipment functionality and if an intermediate XR processing unit is not being used) may receive a dynamic XR local storage indication from RAN node 105, and may adaptively locally store, in response to the local storage indication, indicated protocol data unit (“PDU”) sets (e.g., traffic packets, or packet groups) corresponding to stable information 330, or information extracted from such PDUs, in a local storage buffer for future local payload deliveries. Therefore, when the end XR device/glass appliance 117 requests scheduling of certain XR viewing payload (e.g., stable information), from XR processing unit 115, the XR processing unit may first determine whether the indicated traffic flows, PDU set identifiers, or information is/are marked as stable information for local delivery and thus can be locally provided to the appliance instead of needing to request from RAN node 105 dynamic scheduling of traffic packets that include the stable information. If the XR processing unit determines that information requested by an action performed by appliance 117 is already stored locally, the XR processing unit may retrieve the stable information from the location storage buffer and provide the stable information to the appliance instead of requesting dynamic scheduling of a resource grant from RAN node 105 to receive the information from the RAN node. XR processing unit 115 may provide stable information locally retrieved to appliance 117 via a sidelink communication link 135, or via a private wireless communication link 137 such as Wi-Fi or Bluetooth.

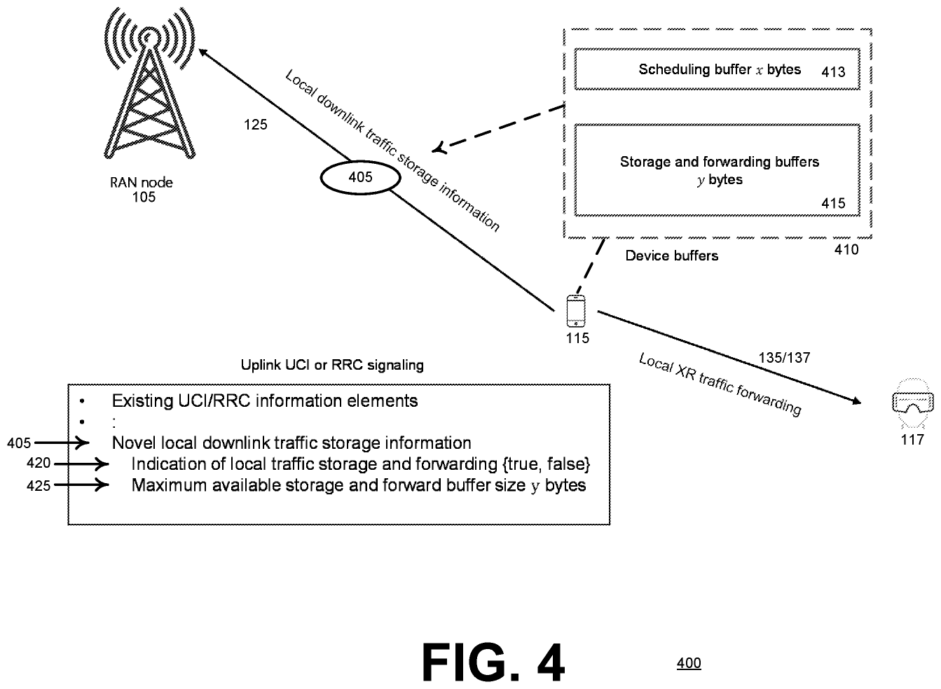

Turning now to FIG. 4, the figure illustrates a local storage capability indication 405 indicative of a local storage capacity corresponding to local storage 415 associated with a user equipment 115 being indicated to radio access network node 105. User equipment 115, which may comprise an XR processor, may be equipped with a large, local traffic storage buffer 415 in addition to a standard decoding buffer 413. Buffers 413 and 415 may be part of a memory portion 410 of user equipment 115 or may be parts of separate memories. User equipment 115 may indicate capability to store information in buffer portion 415 via indication 420 in local storage capability indication 405. Local storage capability indication may comprise a size indication 425 indicative of a size, capacity, or available capacity, of buffer portion 415. Local storage capability indication 405 may be transmitted from UE 115 to RAN node 105 during establishment of an XR session with appliance 117. Available size indication 425 may be useful to RAN node 105 in determining to limit the size of traffic, or information corresponding thereto, such as, for example stable information 330 described in reference to FIG. 3, indicated by a storage indication 315 described in reference to FIG. 3, for storage to local storage 415 to avoid a buffer overflow that may result in loss of traffic or information transmitted by the RAN node to the user equipment. It will be appreciated that in some embodiments appliance 117 may comprise processing and storage buffer 415. In other embodiments, a separate user equipment 115 may facilitate communication with radio access network node 105 and may perform local storage of information, for example stable information 330, to reduce processing, storage and battery consumption by appliance 117. Local storage capability indication 405 may be transmitted to radio access network 105 via an uplink control information message or via a radio resource control message. Local storage capability indication 405 shown in FIG. 4 may be analogous to storage capability information indication 305 shown in FIG. 3.

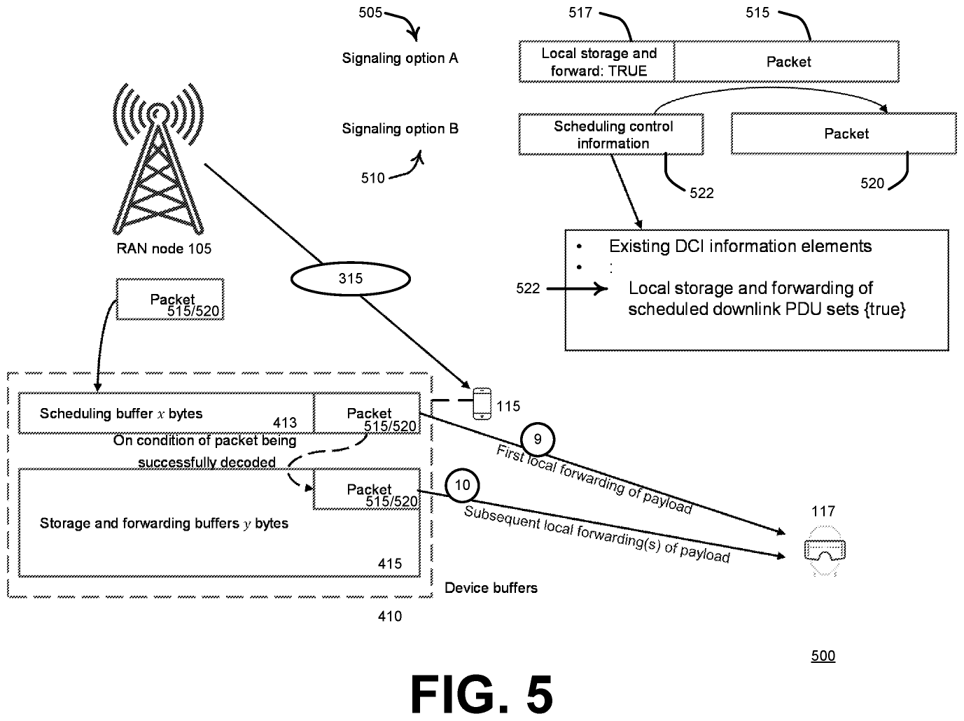

Turning now to FIG. 5, the figure illustrates stable information storage being indicated to user equipment 115. Stable information storage indication 315 (described in reference to FIG. 3) may indicate to user equipment 115 to store stable information to local storage 415. Stable information storage indication 315 may take the form of signaling embodiment 505 (option A). Packet 515 (packet 515 in FIG. 5 may represent multiple packets) is transmitted along with an indication of local storage capability 517. RAN node 105 may append a Medium Access Control control element (“MAC CE”) (e.g., indication 517) to, or transmit the indication with, packet(s) 515 to indicate to user equipment 115 to locally store payload corresponding to the packet(s) for future direct local delivery/deliveries to appliance 117. In signaling embodiment 510 (option B), RAN node 105 may include a local storage indication 522 within a downlink control channel information (“DCI”) message that indicates scheduling of payload 520.

Upon receiving and determining presence of the local storage indication 517 or 522, and received packet(s) 515 or 520, respectively, being successfully decoded, XR processing unit 115 may duplicate the received payload and place the first payload duplicate in conventional buffer 420 for decoding and/or forwarding to appliance 117 at act 9 while storing the second duplicate in the local storage buffer 415 for subsequent forwarding at act 10. For example, the first forwarding at act 9 may be performed in response to a storage indication 315 shown and described in reference to FIG. 3, and one or more subsequent forwarding(s) at act 10 may be performed in response to a retrieval indication 325.

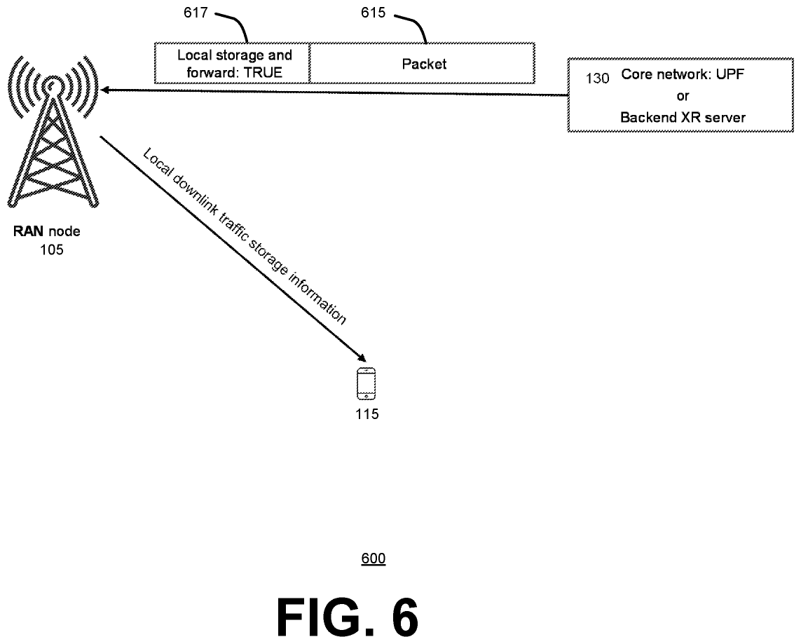

FIGS. 6, 7 and 8 illustrate multiple embodiments to trigger a RAN node to enable local traffic storage at an XR user equipment. FIG. 6 illustrates an example embodiment wherein a component of core network 130 makes a determination to indicate local storing of stable information. As shown in FIG. 6, the core network equipment, for example a UPF or a backend XR server, may append to each packet 615, or to each packet group, delivered to RAN node 105 indication 617 indicating local device storage. Indication 617 may be referred to as a stable information storage indication. In response to stable information storage indication 617, RAN node 105 may transmit/forward to user equipment 115 the stable information storage indication, or another message that indicates that the user equipment is to store stable information traffic (e.g., packet(s) 615). In the scenario illustrated in FIG. 6, core network 130 or an originating XR server may comprise intelligence or knowledge of XR traffic characteristics corresponding to an XR session between UE 115 and appliance 117 and corresponding to stable information being requested by the appliance. Equipment of core network 130 or an XR server may identify that traffic chunks or traffic flows/flow identifiers may be likely to need frequent scheduling by RAN node 105 and that local device storage of the stable information would be more capacity-efficient (if UE 115 or appliance 117 is capable of local storage of the stable information). Thus, the core network or XR server may dynamically enable local traffic storage for packets or traffic flows determined to be stable information.

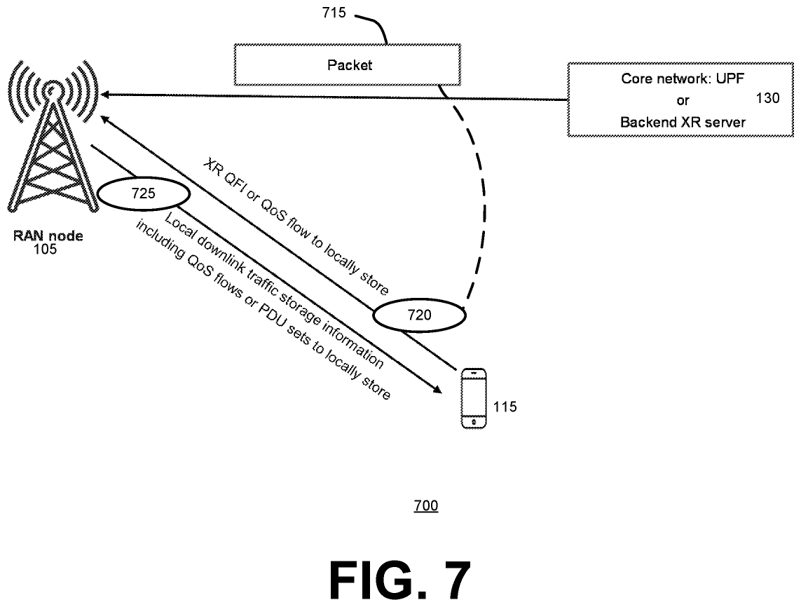

FIG. 7 illustrates an example of local device determination to locally store stable information. In the embodiment shown in FIG. 7, core network 130 may not offer XR-specific information or triggering of messages to RAN node 105 regarding local storage at XR processing unit user equipment 115 of stable traffic. Instead, XR processing unit 115 may provide information to RAN node 105 indicative of stable information that may be regularly requested from the RAN node. In the embodiment shown in FIG. 7, XR processing unit 115 may comprise advanced rendering capability. Accordingly, XR processing unit 115 may generate, or compile, an uplink control message 720, comprising downlink traffic flow identifiers, or downlink PDU set identifiers, corresponding to traffic 715 which is requested in message 720 to be locally stored. RAN node 105 may subsequently transmit stable information message 725, which may be referred to as a stable information storage indication and which may be indicative to the XR processing unit user equipment to store the stable information to a local storage. Message 725 may comprise all of or part of, or indications of all of, or part of, the indicated downlink flows comprising stable information to be locally stored in a local storage corresponding to XR processing unit 115.

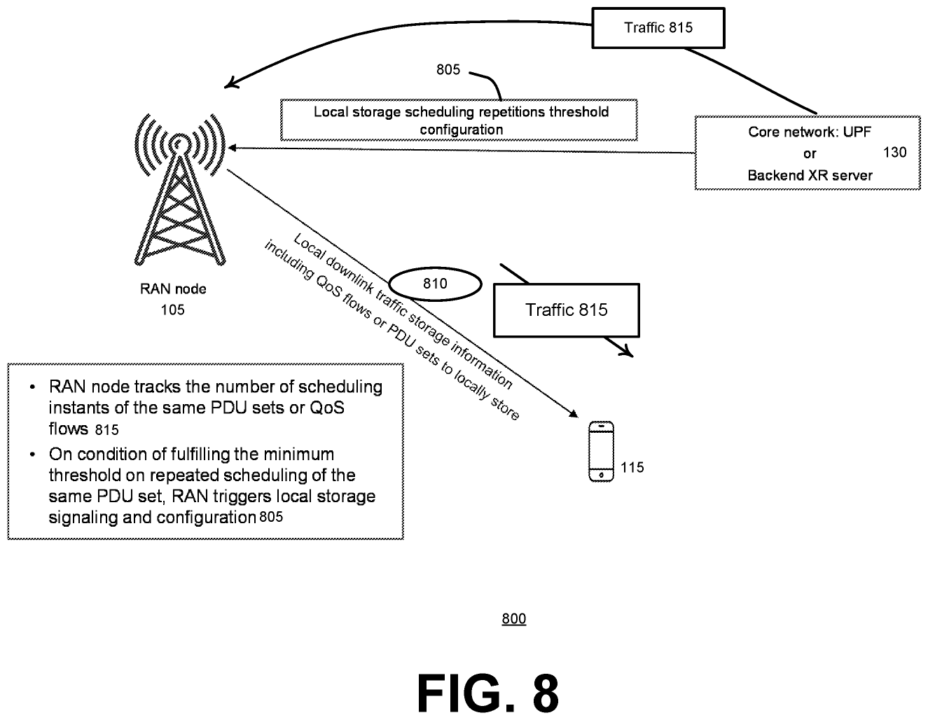

FIG. 8 illustrates an example of radio access network node 105 determining to indicate local storing of stable information. RAN node 105 may only receive a minimum threshold criterion in a local storage scheduling repetitions threshold configuration 805, comprising a configured criterion corresponding to a number of repeated scheduling instants of the same content received from core network 130. When the criterion has been reached (e.g., RAN node 105 has scheduled certain stable information for downlink transmission to XR appliance 115 a number of times that satisfies the criterion received in configuration 805), the RAN node triggers, or indicates, via a stable information storage indication 810, to XR processing unit user equipment 115, to store stable information payload 815 to a local storage corresponding to the XR processing unit user equipment. The embodiment shown in FIG. 8 may be used in situations wherein advanced XR rendering capability is not available at the core network, UE 115, or an XR appliance. (In which case the embodiments shown and described in reference to FIGS. 6 and 7 may not be efficient.) Thus, RAN node 105 may track a number of successful downlink scheduling instants of the same content to each of the active devices. When the configured criterion/threshold indicated in configuration message 805 of repeated scheduling instances is satisfied by the tracked number of successful downlink transmissions of stable traffic 815, the RAN node triggers, via message 810, local storage of traffic/stable information 815 at XR processing unit 115, and thus configures/instructs XR processing unit 115 to locally store scheduled traffic flow(s) 815, or PDU sets, for direct and local forwarding towards an end XR device/glass appliance.

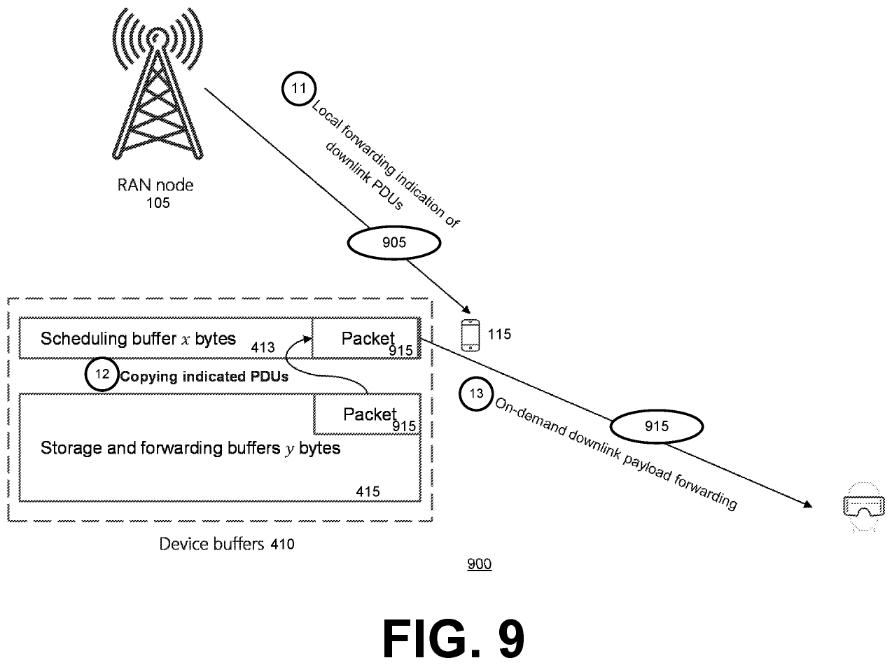

Turning now to FIG. 9, the figure illustrates an example of radio access network node indication of local forwarding of locally stored stable information. As shown in FIG. 9, upon the RAN node have enabled local device traffic storage (based on a trigger as described elsewhere herein) for specific traffic flow or PDUs, the RAN node may transmit at act 11 a downlink local forwarding indication 905, as part of downlink control signaling, (e.g., a DCI message), to indicate to XR processing unit 115 to forward PDU sets, or stored packets, corresponding to stable information, towards end XR device/appliance 117. The embodiment shown in FIG. 9 may be useful with respect to an XR deployment comprising an XR session wherein end XR device/appliance 117 holds, or manages, a control channel to RAN node 105 while XR processing unit 115 holds, or manages, a data channel corresponding to the CR session, to facilitate fast and direct control information exchange without involvement of a middleman (e.g., the XR processing unit), but with the XR processing unit facilitating delivery of data information to the XR appliance. This scenario may arise wherein XR appliance 117 and CR processing unit 115 are manufactured by different manufacturers/vendors. In an embodiment, appliance 117 may have an RRC connections established with RAN node 105 and XR processing unit 115 may have another RRC connection established with the RAN node, wherein the RRC connection between the appliance and RAN node is limited with respect data traffic transmission. Thus, XR processing unit 115 may not be aware that end XR device 117 has requested a dynamic scheduling grant from the RAN node to receive one or more of the traffic PDU set 915 that are already locally buffered om buffer 410 at the XR processing unit. RAN node 105, upon receiving a downlink scheduling request from the end XR device for one or more of the downlink traffic flow or PDU sets, which are locally stored at the processing unit, may not trigger conventional scheduled downlink transmission. Instead, RAN node 115 may transmit indication 905 to XR processing unit 115, indicating traffic flow packet(s) 915 to be locally forwarded towards end XR appliance 117. Thus, the cost of repeated transmissions of the same content is not exhibited, despite the separation of the control and data planes among the end XR device 117 and the in-the-middle processing unit/device 115, (e.g., the only signaling overhead is to facilitate the local forwarding indication downlink signaling message 905). At the XR processing unit, upon receiving local forwarding indication 905 from RAN node 105, may search for the indicated packets 915, PDU sets, or all packets which belong to the indicated flow IDS, within local storage buffer 415, and may duplicate/copy packets 915 to the scheduling/forwarding buffer 413 for local forwarding toward end XR device 117.

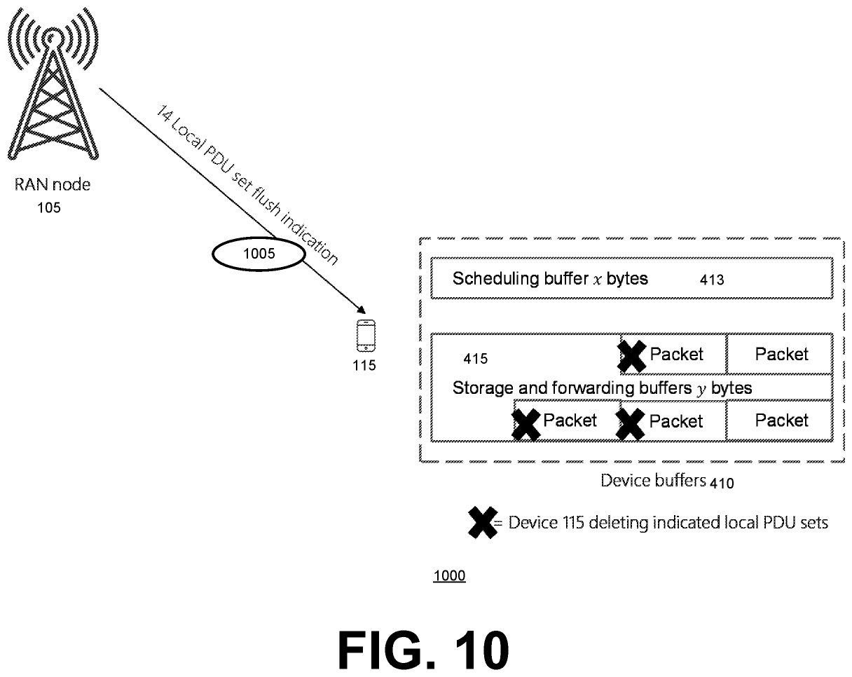

Turning now to FIG. 10, the figure illustrates an example of local storage flushing. As shown in FIG. 10, RAN node 105 may control flushing or deletion of local storage buffer 415 at the XR user equipment device 115. Such flushing may be beneficial with respect to capability conditions corresponding to XR processing unit 115 that vary with respect to time. Examples of changing conditions may include heat dissipation, battery consumption, processor loading, storage capacity of buffer 415 being almost full, and the like. Thus, RAN node 105 may partially, or fully, remove the burden of local traffic storage and forwarding of stable information from XR processing unit user equipment 115. RAN node 105 may transmit a local storage buffer flushing indication 1005, indicating that part of, or all of, the packets, or PDUs, stored in buffer 415, be flushed from buffer 415. Accordingly, XR processing unit 115, upon receiving buffer flushing indication 1005, may delete indicated packet or packet groups from the local storage buffer 415. (Flushed packets are indicated in FIG. 10 with a large ‘X’.) If flushed packets are subsequently requested, or a request for flushed packets is triggered, (e.g., by an action by an XR appliance 117) RAN node 105 may dynamically schedule downlink transmission of the requested packets according to conventional techniques. It will be appreciated that RAN 105 may transmit flush indication 1005 during a period of light network usage, or expected light network usage, such that the scheduling of flushed packets according to conventional techniques does not impact network spectral efficiency. For example, RAN node 105 may refrain from transmitting a flush indication 1005, even if XR processing unit is loaded or experiencing low battery charge, if the radio access network node is itself experiencing heavy usage.

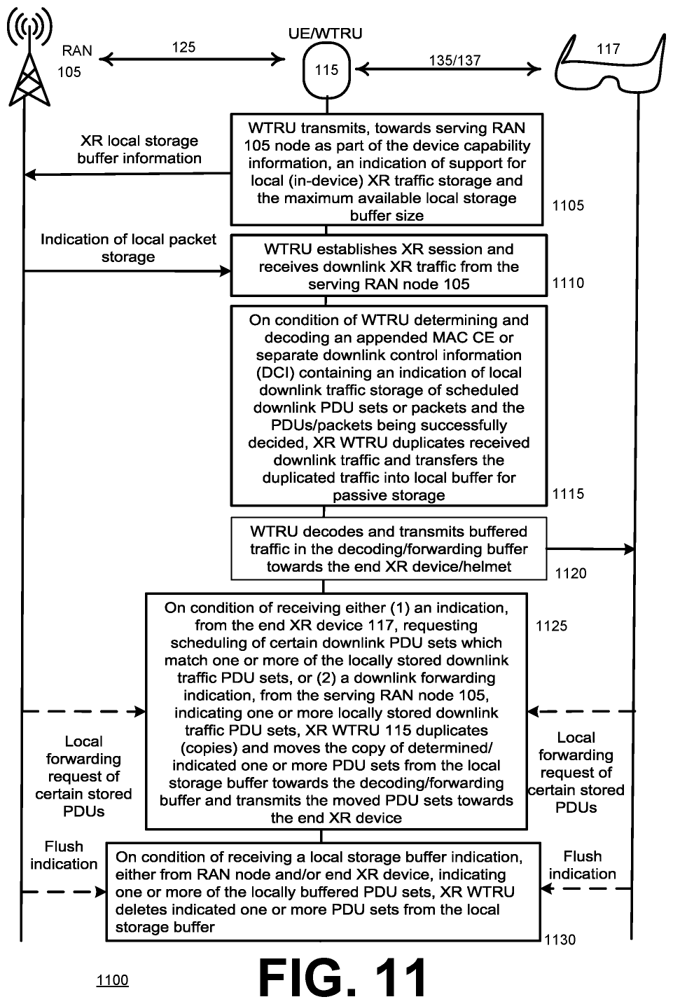

Turning now to FIG. 11, the figure illustrates a timing diagram of an example embodiment method 1100 to locally store and forward, by an intermediate XR processing unit user equipment 115 to a XR appliance 117, stable information. At act 1105, extended reality processing unit user equipment 115 may transmit, towards serving RAN node 105, capability information comprising an indication of support for local storage (e.g., local with respect to the XR processing unit user equipment) of XR traffic/XR information and a maximum available local storage buffer size. The capability information may comprise a local storage capability indication indicative of a local storage capacity corresponding to a local storage associated with user equipment 115. At act 1110, XR WTRU/UE 115 may establish an XR session and may receive downlink XR traffic corresponding to the XR session from serving RAN node 105. On condition of XR processing unit UE/WTRU 115 receiving and decoding a protocol data unit, or PDU set, having a MAC CE appended thereto, transmitted by RAN node 105 at act 1110 and indicative to the UE/WTRU to locally store the downlink PDU or set, or on condition of receiving a separate downlink control information message containing a storage indication, indicative to the UE/WTRU to locally store downlink PDU sets or packets, which PDU sets or packets have been successfully decoded and correspond to the storage indication, at act 1115 the XR processing unit UE/WTRU may duplicate the received downlink traffic PDU or PDU set(s) and transfer the duplicated traffic/information into a local storage buffer (e.g., storage buffer 415 shown in FIG. 4) for passive storage (e.g., not necessarily for immediate forwarding to appliance 117). At act 1120, XR processing unit user equipment 115 may decode traffic/information stored in the storage buffer, transfer the decoded traffic/information to a forwarding buffer (e.g., buffer 413 shown in FIG. 4), and transmit the decoded traffic/information stored in the forwarding buffer towards end XR device/helmet/appliance 117. At act 1125, on condition of receiving an indication from end XR appliance 117 requesting scheduling of certain downlink PDU sets, which match one or more of the locally stored downlink traffic PDU sets, or one condition of receiving a downlink forwarding indication (e.g., an indication a retrieval indication 325 shown in FIG. 3) from serving RAN node 105 instructing XR processing unit 115 to forward one or more locally stored downlink traffic PDU sets or stored stable information, the XR processing unit UE/WTRU may duplicate (e.g., copy) and transfer the copy of the one or more indicated PDU sets, or information, from local storage buffer (e.g., buffer 415 shown in FIG. 4) to a decoding/forwarding buffer (e.g., buffer 413 shown in FIG. 4) and transmit the copied/duplicated PDU set(s)/information towards end XR device/appliance 117. On condition of receiving a local storage flush buffer indication, either from RAN node 105 or from end XR device/appliance 117, indicating one or more of the locally stored/buffered PDU set(s)/information, XR processing unit UE/WTRU 115 may delete the indicated one or more PDU set(s)/information from the local storage buffer at act 1130.

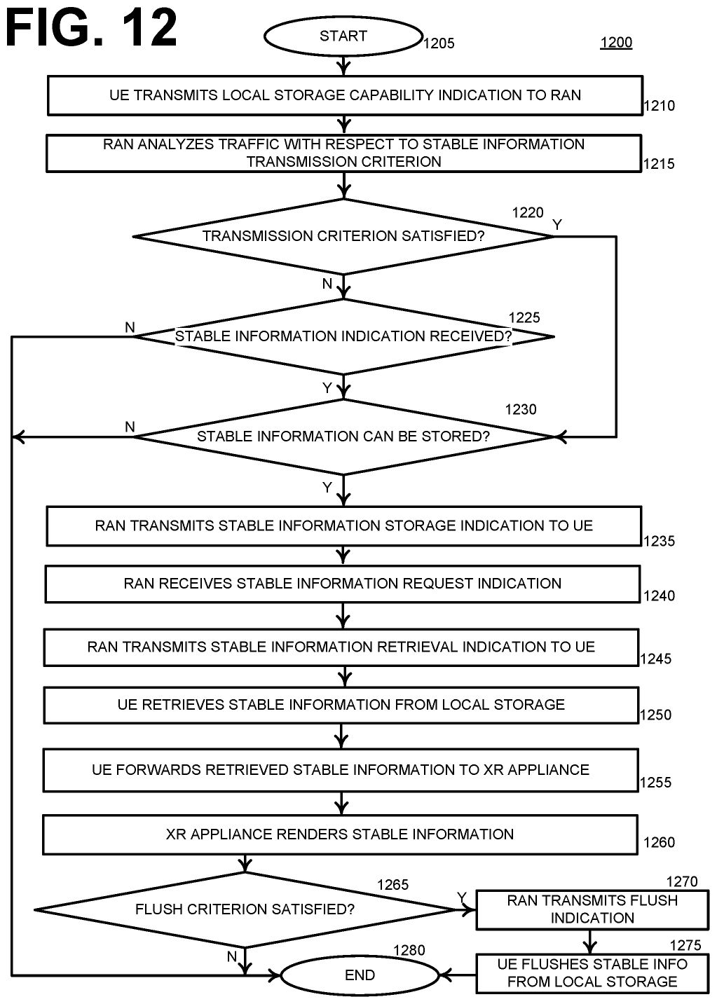

Turning now to FIG. 12, the figure illustrates a flow diagram of an example embodiment 1200. Method 1200 begins at act 1205. At act 1210, a user equipment may transmit a local storage capability indication to a radio access network node. The local storage capability indication may comprise an indication indicative that the user equipment is configured, or is enabled, to store staple information in a local storage/buffer corresponding to the user equipment. The local storage capability indication may comprise an indication of a size of the local storage/buffer or the local storage capability indication may comprise an indication of an available size of the local storage/buffer. Examples of a user equipment may include a smartphone, a tablet, a router, a laptop computer, or an extended reality processing unit that may comprise modem circuitry for communicating with the radio access network node and one or more memories, or storage, to facilitate storage of extended reality traffic, or information, delivered to an extended reality appliance via the extended reality traffic. The user equipment, for example an extended reality processing unit, may facilitate an extended reality session with the radio access network node and an extended reality appliance.

At act 1215, the radio access network node may analyze traffic corresponding to an extended reality session. The analysis performed by the radio access network node at act 1215 may comprise evaluating the traffic with respect to a stable information transmission criterion. The analysis performed at act 1215 may comprise determining whether the received traffic comprises an indication of stable information. The determination, or indication, of whether the traffic comprises stable information may be determined by the radio access network node, by a core network equipment/component, or by the user equipment. Analysis performed at act 1215 may comprise determining whether certain stable information has been transmitted by the radio access network node to the user equipment more than a configured number of times. At act 1220, the radio access network node may determine whether the transmission criterion has been satisfied. For example, if the certain stable information has been transmitted by the radio access network node to the user equipment more than the configured number of times, radio access network node may determine at act 1230 whether the stable information can be locally stored at the user equipment. The radio access network node may make the determination at act 1230 whether the certain stable information can be stored locally at the user equipment based on the storage capability indication transmitted by the user equipment at act 1210.

Returning to description of act 1220, if the radio access network node determines that the stable information transmission criterion has not been satisfied, method 1200 may advance to act 1225. At act 1225, the radio access network node may determine whether a stable information indication has been received. An example of a stable information indication may be indication 310 shown and described in reference to FIG. 3. If a determination is made at act 1225 that a stable information indication has not been received, method 1200 advances to act 1280 and ends. If the radio access network node determines at act 1225 that a stable information indication has been received, method 1200 advances to act 1230. If the radio access network node determines at act 1230 that stable information that may have been indicated by a stable information indication received at act 1225, or stable information analyzed at act 1215, cannot be stored locally at the user equipment, for example because the local storage indicated in the local storage capability indication that the user equipment transmitted it at 1210 is either not enabled to store stable information or does not have enough available space to store stable information, method 1200 advances to act 1280 and ends.

If a determination is made at act 1230 that stable information, indicated at act 1225 or analyzed at act 1215 for example, can be stored locally at the user equipment, at act 1235 the radio access network node may transmit a stable information storage indication (e.g., storage indication 315 described in reference to FIG. 3) to the user equipment and the user equipment may store stable information indicated in the stable information storage indication to a local storage, or local buffer, corresponding to the user equipment.

At act 1240, the radio access network node may receive a stable information request indication (e.g., stable information request 320 described in reference to FIG. 3), which may be received from the user equipment, or which may be received from a component of, or equipment corresponding to, core network 130 shown and described in reference to FIG. 1. The stable information request indication may be triggered by an extended reality appliance, used by a user during an extended reality session being facilitated by the user equipment, looking at, pointing at, clicking at, or performing some other selection action with respect to an object corresponding to the stable information.

Continuing with description of FIG. 12, at act 1245, the radio access network node may transmit a stable information retrieval indication to the user equipment. The stable information retrieval indication may indicate to the user equipment to retrieve, from the local storage, stable information indicated in the stable information retrieval indication. At act 1250, in response to receiving the stable information retrieval indication, the user equipment may retrieve the indicated stable information from a local storage. The user equipment may duplicate, or copy, the retrieved stable information stored in the local storage and transfer the copied version of the stable information to a scheduling buffer and the user equipment may forward the stable information stored in the scheduling buffer to an extended reality appliance at 1255. The user equipment may duplicate, or copy the retrieved stable information stored in the local storage buffer instead of moving the retrieved stable information so that the stable information remains in the local storage buffer for a future, or subsequent, retrieval and forwarding of the same stable information to the extended reality appliance during the extended reality session. At act 1260, the extended reality appliance may render the stable information such that a user using the extended reality appliance may view the stable information in response to a triggering action, such as gazing toward an object corresponding to the stable information, that may have caused the sending of the stable information request indication that the radio access network node received at act 1240.

At act 1265, the radio access network node may determine whether a local storage flush criterion has been satisfied. For example, if the radio access network node determines that channel conditions between the radio access network node and the user equipment have improved since the radio access network node transmitted a stable information storage indication to the user equipment at act 1235, the radio access network node may determine that transmitting stable information to the user equipment according to conventional scheduling techniques every time the stable information is requested may reduce processing/processor loading, storage usage, or battery consumption that may be used to facilitate local storing of stable information at the user equipment. If the radio access network node does not determine that a local storage flush criterion has been satisfied, method 1200 advances to act 1280 and ends. If the radio access network node determines at act 1265 that a local storage flush criterion has been satisfied, method 1200 may advance to act 1270. At act 1270, the radio access network node may transmit a local storage flush indication message to the user equipment indicative to the user equipment to flush stable information, which may comprise stable information indicated for storage at act 1235, from a local storage buffer corresponding to the user equipment. At act 1275, responsive to the local storage flush indication, the user equipment may flush stable information from a local storage corresponding to the user equipment pause dictation. Method 1200 advances from act 1275 to act 1280 and ends.

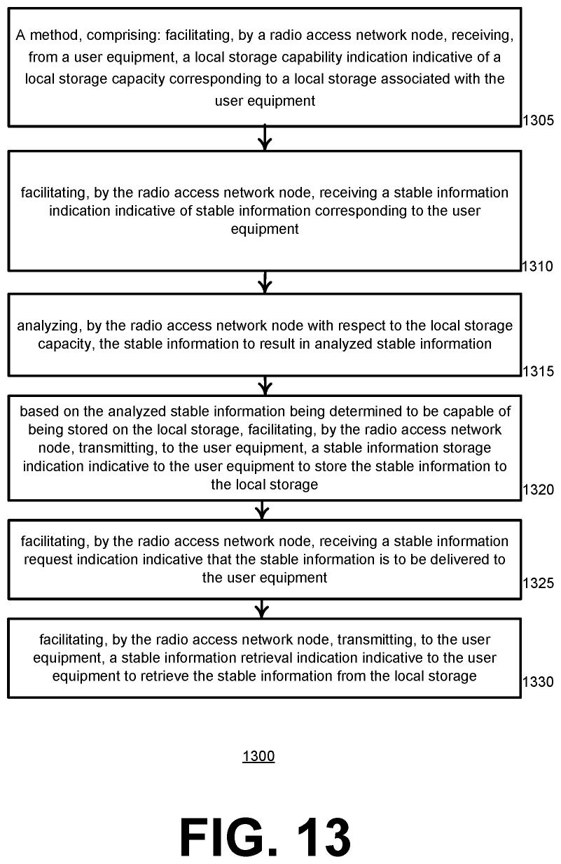

Turning now to FIG. 13, the figure illustrates an example embodiment method 1300 comprising at block 1305 facilitating, by a radio access network node, receiving, from a user equipment, a local storage capability indication indicative of a local storage capacity corresponding to a local storage associated with the user equipment; at act 1310 facilitating, by the radio access network node, receiving a stable information indication indicative of stable information corresponding to the user equipment; at act 1315 analyzing, by the radio access network node with respect to the local storage capacity, the stable information to result in analyzed stable information; at act 1320 based on the analyzed stable information being determined to be capable of being stored on the local storage, facilitating, by the radio access network node, transmitting, to the user equipment, a stable information storage indication indicative to the user equipment to store the stable information to the local storage; at act 1325 facilitating, by the radio access network node, receiving a stable information request indication indicative that the stable information is to be delivered to the user equipment; and at block 1330 facilitating, by the radio access network node, transmitting, to the user equipment, a stable information retrieval indication indicative to the user equipment to retrieve the stable information from the local storage.

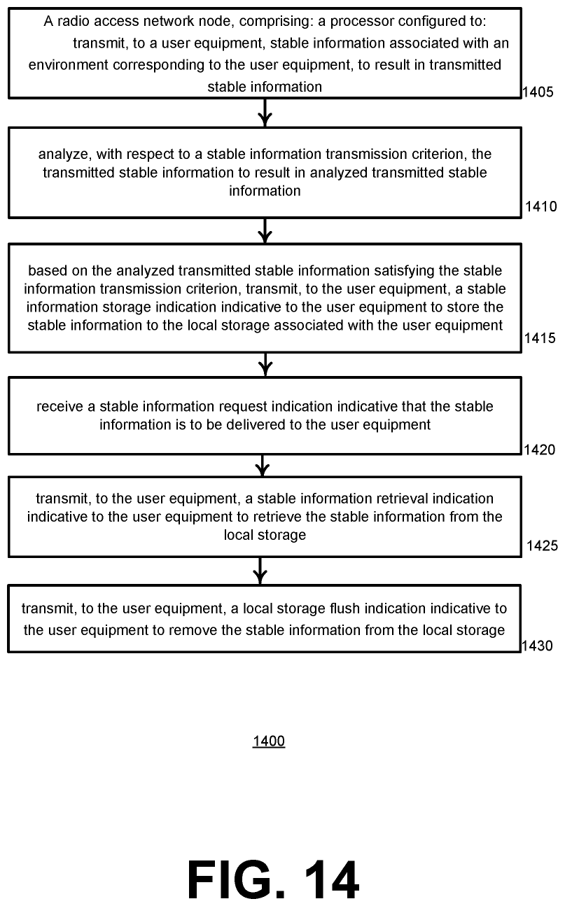

Turning now to FIG. 14, the figure illustrates an example radio access network node, comprising at block 1405 a processor configured to transmit, to a user equipment, stable information associated with an environment corresponding to the user equipment, to result in transmitted stable information; at block 1410 analyze, with respect to a stable information transmission criterion, the transmitted stable information to result in analyzed transmitted stable information; at block 1415 based on the analyzed transmitted stable information satisfying the stable information transmission criterion, transmit, to the user equipment, a stable information storage indication indicative to the user equipment to store the stable information to the local storage associated with the user equipment; at block 1420 receive a stable information request indication indicative that the stable information is to be delivered to the user equipment; at block 1425 transmit, to the user equipment, a stable information retrieval indication indicative to the user equipment to retrieve the stable information from the local storage; and at block 1430 transmit, to the user equipment, a local storage flush indication indicative to the user equipment to remove the stable information from the local storage.

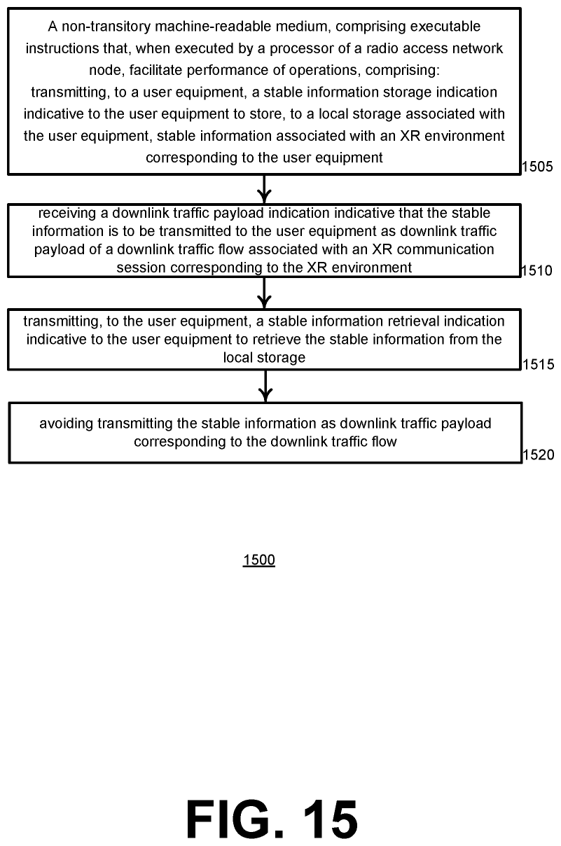

Turning now to FIG. 15, the figure illustrates a non-transitory machine-readable medium 1500 comprising at block 1505 executable instructions that, when executed by a processor of a radio access network node, facilitate performance of operations, comprising transmitting, to a user equipment, a stable information storage indication indicative to the user equipment to store, to a local storage associated with the user equipment, stable information associated with an XR environment corresponding to the user equipment; at block 1510 receiving a downlink traffic payload indication indicative that the stable information is to be transmitted to the user equipment as downlink traffic payload of a downlink traffic flow associated with an XR communication session corresponding to the XR environment; at block 1515 transmitting, to the user equipment, a stable information retrieval indication indicative to the user equipment to retrieve the stable information from the local storage; and at block 1520 avoiding transmitting the stable information as downlink traffic payload corresponding to the downlink traffic flow.

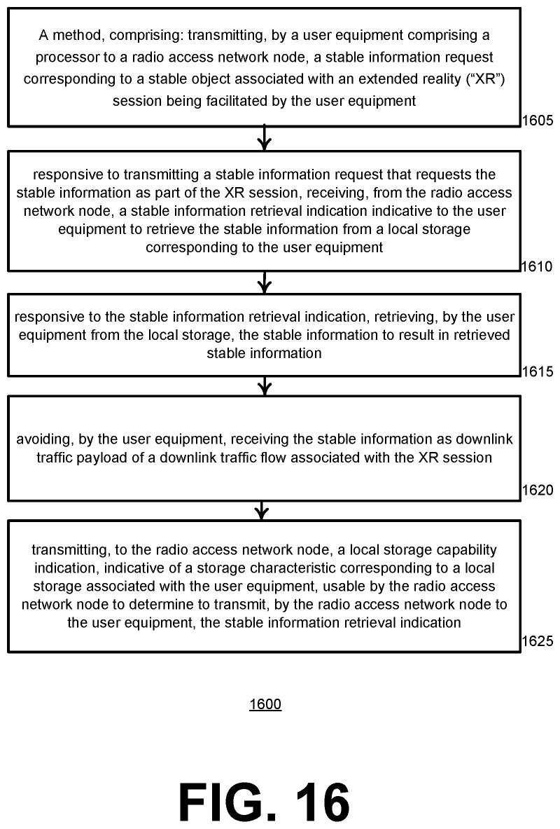

Turning now to FIG. 16, the figure illustrates an example embodiment method 1600 comprising at block 1605 transmitting, by a user equipment comprising a processor to a radio access network node, a stable information request corresponding to a stable object associated with an extended reality (“XR”) session being facilitated by the user equipment; at block 1610 responsive to transmitting a stable information request that requests the stable information as part of the XR session, receiving, from the radio access network node, a stable information retrieval indication indicative to the user equipment to retrieve the stable information from a local storage corresponding to the user equipment; at block 1615 responsive to the stable information retrieval indication, retrieving, by the user equipment from the local storage, the stable information to result in retrieved stable information; at block 1620 avoiding, by the user equipment, receiving the stable information as downlink traffic payload of a downlink traffic flow associated with the XR session; and at block 1625 transmitting, to the radio access network node, a local storage capability indication, indicative of a storage characteristic corresponding to a local storage associated with the user equipment, usable by the radio access network node to determine to transmit, by the radio access network node to the user equipment, the stable information retrieval indication.

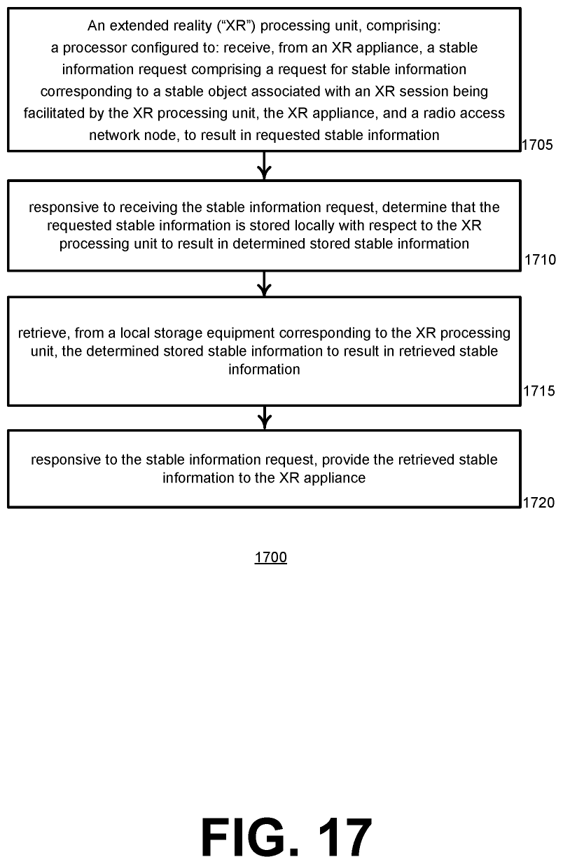

Turning now to FIG. 17, the figure illustrates an example XR processing unit 1700, comprising at block 1705 a processor configured to receive, from an XR appliance, a stable information request comprising a request for stable information corresponding to a stable object associated with an XR session being facilitated by the XR processing unit, the XR appliance, and a radio access network node, to result in requested stable information; at block 1710 responsive to receiving the stable information request, determine that the requested stable information is stored locally with respect to the XR processing unit to result in determined stored stable information; at block 1715 retrieve, from a local storage equipment corresponding to the XR processing unit, the determined stored stable information to result in retrieved stable information; and at block responsive to the stable information request, provide the retrieved stable information to the XR appliance.

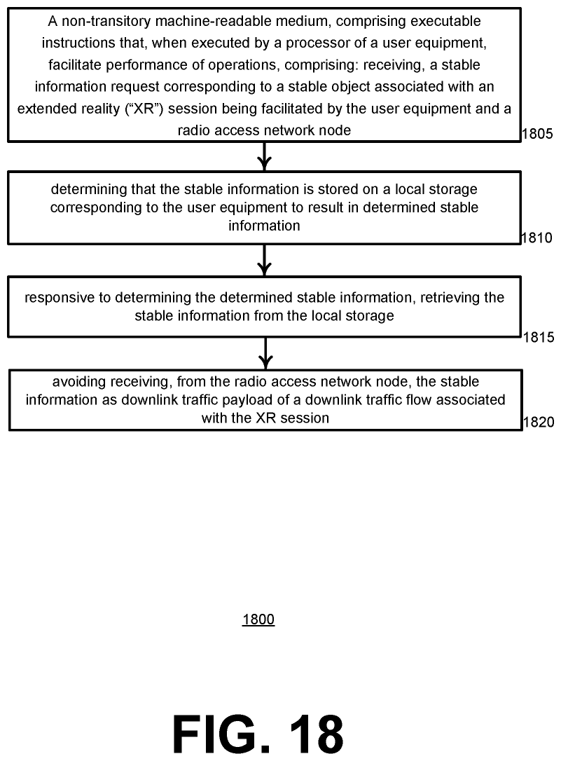

Turning now to FIG. 18, the figure illustrates a non-transitory machine-readable medium 1800 comprising at block 1805 executable instructions that, when executed by a processor of a user equipment, facilitate performance of operations, comprising receiving, a stable information request corresponding to a stable object associated with an extended reality (“XR”) session being facilitated by the user equipment and a radio access network node; at block 1810 determining that the stable information is stored on a local storage corresponding to the user equipment to result in determined stable information; at block 1815 responsive to determining the determined stable information, retrieving the stable information from the local storage; and at block 1820 avoiding receiving, from the radio access network node, the stable information as downlink traffic payload of a downlink traffic flow associated with the XR session.

In order to provide additional context for various embodiments described herein, FIG. 19 and the following discussion are intended to provide a brief, general description of a suitable computing environment 1900 in which various embodiments of the embodiment described herein can be implemented. While embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 19, the example environment 1900 for implementing various embodiments described herein includes a computer 1902, the computer 1902 including a processing unit 1904, a system memory 1906 and a system bus 1908. The system bus 1908 couples system components including, but not limited to, the system memory 1906 to the processing unit 1904. The processing unit 1904 can be any of various commercially available processors and may include a cache memory. Dual microprocessors and other multi-processor architectures can also be employed as the processing unit 1904.

The system bus 1908 can be any of several types of bus structure that can further interconnect to a memory bus (with or without a memory controller), a peripheral bus, and a local bus using any of a variety of commercially available bus architectures. The system memory 1906 includes ROM 1910 and RAM 1912. A basic input/output system (BIOS) can be stored in a non-volatile memory such as ROM, erasable programmable read only memory (EPROM), EEPROM, which BIOS contains the basic routines that help to transfer information between elements within the computer 1902, such as during startup. The RAM 1912 can also include a high-speed RAM such as static RAM for caching data.

Computer 1902 further includes an internal hard disk drive (HDD) 1914 (e.g., EIDE, SATA), one or more external storage devices 1916 (e.g., a magnetic floppy disk drive (FDD) 1916, a memory stick or flash drive reader, a memory card reader, etc.) and an optical disk drive 1920 (e.g., which can read or write from a CD-ROM disc, a DVD, a BD, etc.). While the internal HDD 1914 is illustrated as located within the computer 1902, the internal HDD 1914 can also be configured for external use in a suitable chassis (not shown). Additionally, while not shown in environment 1900, a solid-state drive (SSD) could be used in addition to, or in place of, an HDD 1910. The HDD 1914, external storage device(s) 1916 and optical disk drive 1920 can be connected to the system bus 1908 by an HDD interface 1924, an external storage interface 1926 and an optical drive interface 1928, respectively. The interface 1924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1912, including an operating system 1930, one or more application programs 1932, other program modules 1934 and program data 1936. All or portions of the operating system, applications, modules, and/or data can also be cached in the RAM 1912. The systems and methods described herein can be implemented utilizing various commercially available operating systems or combinations of operating systems.

Computer 1902 can optionally comprise emulation technologies. For example, a hypervisor (not shown) or other intermediary can emulate a hardware environment for operating system 1930, and the emulated hardware can optionally be different from the hardware illustrated in FIG. 19. In such an embodiment, operating system 1930 can comprise one virtual machine (VM) of multiple VMs hosted at computer 1902. Furthermore, operating system 1930 can provide runtime environments, such as the Java runtime environment or the .NET framework, for applications 1932. Runtime environments are consistent execution environments that allow applications 1932 to run on any operating system that includes the runtime environment. Similarly, operating system 1930 can support containers, and applications 1932 can be in the form of containers, which are lightweight, standalone, executable packages of software that include, e.g., code, runtime, system tools, system libraries and settings for an application.

Further, computer 1902 can comprise a security module, such as a trusted processing module (TPM). For instance, with a TPM, boot components hash next in time boot components, and wait for a match of results to secured values, before loading a next boot component. This process can take place at any layer in the code execution stack of computer 1902, e.g., applied at the application execution level or at the operating system (OS) kernel level, thereby enabling security at any level of code execution.

A user can enter commands and information into the computer 1902 through one or more wired/wireless input devices, e.g., a keyboard 1938, a touch screen 1940, and a pointing device, such as a mouse 1942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1904 through an input device interface 1944 that can be coupled to the system bus 1908, but can be connected by other interfaces, such as a parallel port, an IEEE 1394 serial port, a game port, a USB port, an IR interface, a BLUETOOTH® interface, etc.

A monitor 1946 or other type of display device can be also connected to the system bus 1908 via an interface, such as a video adapter 1948. In addition to the monitor 1946, a computer typically includes other peripheral output devices (not shown), such as speakers, printers, etc.

The computer 1902 can operate in a networked environment using logical connections via wired and/or wireless communications to one or more remote computers, such as a remote computer(s) 1950. The remote computer(s) 1950 can be a workstation, a server computer, a router, a personal computer, portable computer, microprocessor-based entertainment appliance, a peer device or other common network node, and typically includes many or all of the elements described relative to the computer 1902, although, for purposes of brevity, only a memory/storage device 1952 is illustrated. The logical connections depicted include wired/wireless connectivity to a local area network (LAN) 1954 and/or larger networks, e.g., a wide area network (WAN) 1956. Such LAN and WAN networking environments are commonplace in offices and companies, and facilitate enterprise-wide computer networks, such as intranets, all of which can connect to a global communications network, e.g., the internet.

When used in a LAN networking environment, the computer 1902 can be connected to the local network 1954 through a wired and/or wireless communication network interface or adapter 1958. The adapter 1958 can facilitate wired or wireless communication to the LAN 1954, which can also include a wireless access point (AP) disposed thereon for communicating with the adapter 1958 in a wireless mode.

When used in a WAN networking environment, the computer 1902 can include a modem 1960 or can be connected to a communications server on the WAN 1956 via other means for establishing communications over the WAN 1956, such as by way of the internet. The modem 1960, which can be internal or external and a wired or wireless device, can be connected to the system bus 1908 via the input device interface 1944. In a networked environment, program modules depicted relative to the computer 1902 or portions thereof, can be stored in the remote memory/storage device 1952. It will be appreciated that the network connections shown are examples and other means of establishing a communications link between the computers can be used.

When used in either a LAN or WAN networking environment, the computer 1902 can access cloud storage systems or other network-based storage systems in addition to, or in place of, external storage devices 1916 as described above. Generally, a connection between the computer 1902 and a cloud storage system can be established over a LAN 1954 or WAN 1956 e.g., by the adapter 1958 or modem 1960, respectively. Upon connecting the computer 1902 to an associated cloud storage system, the external storage interface 1926 can, with the aid of the adapter 1958 and/or modem 1960, manage storage provided by the cloud storage system as it would other types of external storage. For instance, the external storage interface 1926 can be configured to provide access to cloud storage sources as if those sources were physically connected to the computer 1902.

The computer 1902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

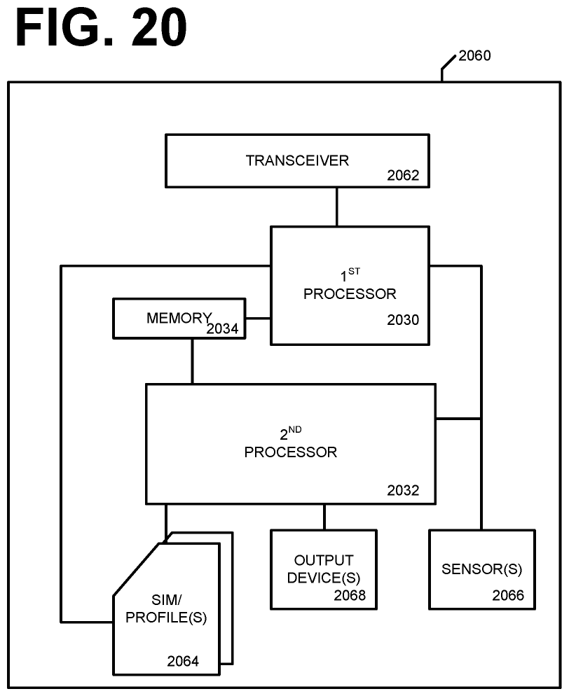

Turning now to FIG. 20, the figure illustrates a block diagram of an example UE 2060. UE 2060 may comprise a smart phone, a wireless tablet, a laptop computer with wireless capability, a wearable device, a machine device that may facilitate vehicle telematics, and the like. UE 2060 comprises a first processor 2030, a second processor 2032, and a shared memory 2034. UE 2060 includes radio front end circuitry 2062, which may be referred to herein as a transceiver, but is understood to typically include transceiver circuitry, separate filters, and separate antennas for facilitating transmission and receiving of signals over a wireless link, such as one or more wireless links 125, 135, or 137 shown in FIG. 1. Furthermore, transceiver 2062 may comprise multiple sets of circuitry or may be tunable to accommodate different frequency ranges, different modulations schemes, or different communication protocols, to facilitate long-range wireless links such as links, device-to-device links, such as links 135, and short-range wireless links, such as links 137.

Continuing with description of FIG. 20, UE 2060 may also include a SIM 2064, or a SIM profile, which may comprise information stored in a memory (memory 2034 or a separate memory portion), for facilitating wireless communication with RAN 105 or core network 130 shown in FIG. 1. FIG. 20 shows SIM 2064 as a single component in the shape of a conventional SIM card, but it will be appreciated that SIM 2064 may represent multiple SIM cards, multiple SIM profiles, or multiple eSIMs, some or all of which may be implemented in hardware or software. It will be appreciated that a SIM profile may comprise information such as security credentials (e.g., encryption keys, values that may be used to generate encryption keys, or shared values that are shared between SIM 2064 and another device, which may be a component of RAN 105 or core network 130 shown in FIG. 1). A SIM profile 2064 may also comprise identifying information that is unique to the SIM, or SIM profile, such as, for example, an International Mobile Subscriber Identity (“IMSI”) or information that may make up an IMSI.

SIM 2064 is shown coupled to both the first processor portion 2030 and the second processor portion 2032. Such an implementation may provide an advantage that first processor portion 2030 may not need to request or receive information or data from SIM 2064 that second processor 2032 may request, thus eliminating the use of the first processor acting as a ‘go-between’ when the second processor uses information from the SIM in performing its functions and in executing applications. First processor 2030, which may be a modem processor or baseband processor, is shown smaller than processor 2032, which may be a more sophisticated application processor, to visually indicate the relative levels of sophistication (i.e., processing capability and performance) and corresponding relative levels of operating power consumption levels between the two processor portions. Keeping the second processor portion 2032 asleep/inactive/in a low power state when UE 2060 does not need it for executing applications and processing data related to an application provides an advantage of reducing power consumption when the UE only needs to use the first processor portion 2030 while in listening mode for monitoring routine configured bearer management and mobility management/maintenance procedures, or for monitoring search spaces that the UE has been configured to monitor while the second processor portion remains inactive/asleep.

UE 2060 may also include sensors 2066, such as, for example, temperature sensors, accelerometers, gyroscopes, barometers, moisture sensors, and the like that may provide signals to the first processor 2030 or second processor 2032. Output devices 2068 may comprise, for example, one or more visual displays (e.g., computer monitors, VR appliances, and the like), acoustic transducers, such as speakers or microphones, vibration components, and the like. Output devices 2068 may comprise software that interfaces with output devices, for example, visual displays, speakers, microphones, touch sensation devices, smell or taste devices, and the like, that are external to UE 2060.

The following glossary of terms given in Table 1 may apply to one or more descriptions of embodiments disclosed herein.

TABLE 1

| Term | Definition |
|---|---|
| UE | User equipment |
| WTRU | Wireless transmit receive unit |
| RAN | Radio access network |
| QoS | Quality of service |
| DRX | Discontinuous reception |
| EPI | Early paging indication |
| DCI | Downlink control information |
| SSB | Synchronization signal block |
| RS | Reference signal |
| PDCCH | Physical downlink control channel |
| PDSCH | Physical downlink shared channel |
| MUSIM | Multi-SIM UE |
| SIB | System information block |
| MIB | Master information block |
| eMBB | Enhanced mobile broadband |
| URLLC | Ultra reliable and low latency communications |
| mMTC | Massive machine type communications |
| XR | Anything-reality |
| VR | Virtual reality |
| AR | Augmented reality |
| MR | Mixed reality |
| DCI | Downlink control information |
| DMRS | Demodulation reference signals |
| QPSK | Quadrature Phase Shift Keying |
| WUS | Wake up signal |
| HARQ | Hybrid automatic repeat request |
| RRC | Radio resource control |
| C-RNTI | Connected mode radio network temporary identifier |
| CRC | Cyclic redundancy check |
| MIMO | Multi input multi output |
| UE | User equipment |
| CBR | Channel busy ratio |
| SCI | Sidelink control information |
| SBFD | Sub-band full duplex |
| CLI | Cross link interference |
| TDD | Time division duplexing |
| FDD | Frequency division duplexing |
| BS | Base-station |
| RS | Reference signal |
| CSI-RS | Channel state information reference signal |
| PTRS | Phase tracking reference signal |
| DMRS | Demodulation reference signal |
| gNB | General NodeB |
| PUCCH | Physical uplink control channel |
| PUSCH | Physical uplink shared channel |
| SRS | Sounding reference signal |
| NES | Network energy saving |
| QCI | Quality class indication |
| RSRP | Reference signal received power |
| PCI | Primary cell ID |
| BWP | Bandwidth Part |

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” or variations thereof as may be used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a radio access network node, receiving, from a user equipment, a local storage capability indication indicative of a local storage capacity corresponding to a local storage associated with the user equipment;
facilitating, by the radio access network node, receiving a stable information indication indicative of stable information corresponding to the user equipment;
analyzing, by the radio access network node with respect to the local storage capacity, the stable information to result in analyzed stable information;
based on the analyzed stable information being determined to be capable of being stored on the local storage, facilitating, by the radio access network node, transmitting, to the user equipment, a stable information storage indication indicative to the user equipment to store the stable information to the local storage;
facilitating, by the radio access network node, receiving a stable information request indication indicative that the stable information is to be delivered to the user equipment; and
facilitating, by the radio access network node, transmitting, to the user equipment, a stable information retrieval indication indicative to the user equipment to retrieve the stable information from the local storage.

2. The method of claim 1, wherein the stable information indication is received from core network equipment.

3. The method of claim 1, wherein the stable information indication is received from the user equipment.

4. The method of claim 1, further comprising:
facilitating, by the radio access network node, transmitting, to the user equipment, the stable information as stable information downlink traffic,
wherein the stable information storage indication comprises a medium access control control element corresponding to the stable information downlink traffic.

5. The method of claim 1, further comprising:
facilitating, by the radio access network node, transmitting, to the user equipment, the stable information as stable information downlink traffic payload,
wherein the stable information storage indication comprises a downlink control information message element corresponding to the stable information downlink traffic.

6. The method of claim 1, further comprising:
facilitating, by the radio access network node, transmitting, to the user equipment, a local storage flush indication indicative to the user equipment to remove the stable information from the local storage.

7. The method of claim 6, wherein the determining to transmit the local storage flush indication is facilitated by the radio access network node based on a size of the stable information and a local size, indicated in the local storage capability indication, corresponding to the local storage.

8. The method of claim 6, wherein the determining to transmit the local storage flush indication is facilitated by the radio access network node based on an age of the stable information in the local storage.

9. The method of claim 6, wherein the stable information retrieval indication is a first stable information retrieval indication, the method further comprising:
determining, by the radio access network node, that at least one transmission, facilitated by the radio access network node, of at least one subsequent stable information retrieval indication, subsequent to transmission of the first stable information retrieval indication, satisfies a stable information retrieval indication criterion, to result in a determined at least one subsequent stable information retrieval indication; and
based on the at least one subsequent stable information retrieval indication satisfying the stable information retrieval indication criterion, determining, by the radio access network node, to transmit the local storage flush indication,
wherein determining to transmit the local storage flush indication is facilitated by the radio access network node based on transmission of at least one stable information retrieval indication.

10. The method of claim 6, wherein the stable information is partial stable information and wherein the local storage flush indication comprises a full local storage flush indication indicative to the user equipment to flush all stable information, that comprises the partial stable information, from the local storage.

11. The method of claim 1, further comprising:
determining, by the radio access network node, a channel condition metric corresponding to at least one channel condition parameter; and
analyzing, by the radio access network node, the channel condition metric with respect to a channel condition criterion, to result in an analyzed channel condition metric,
wherein the radio access network node transmits the stable information storage indication to the user equipment based on the analyzed channel condition metric failing to satisfy the channel condition criterion.

12. The method of claim 11, wherein the channel condition metric is a first channel condition metric and wherein the analyzed channel condition metric is an analyzed first channel condition metric, the method further comprising:
determining, by the radio access network node, a second channel condition metric corresponding to the at least one channel condition parameter;
analyzing, by the radio access network node, the second channel condition metric with respect to the channel condition criterion, to result in an analyzed second channel condition metric; and
based on determining that the analyzed second channel condition metric satisfies the channel condition criterion being facilitated by the radio access network node, facilitating, by the radio access network node, transmitting, to the user equipment, a local storage flush indication indicative to the user equipment to remove the stable information from the local storage.

13. A radio access network node, comprising:
a processor configured to:
transmit, to a user equipment, stable information associated with an environment corresponding to the user equipment, to result in transmitted stable information;
analyze, with respect to a stable information transmission criterion, the transmitted stable information to result in analyzed transmitted stable information;
based on the analyzed transmitted stable information satisfying the stable information transmission criterion, transmit, to the user equipment, a stable information storage indication indicative to the user equipment to store the stable information to the local storage associated with the user equipment;
receive a stable information request indication indicative that the stable information is to be delivered to the user equipment, and
transmit, to the user equipment, a stable information retrieval indication indicative to the user equipment to retrieve the stable information from the local storage.

14. The radio access network node of claim 13, wherein the processor is further configured to:
transmit, to the user equipment, a local storage flush indication indicative to the user equipment to remove the stable information from the local storage.

15. The radio access network node of claim 13, wherein the stable information transmission criterion comprises a configured number of instances of transmission, by the radio access network node to the user equipment, of the stable information, and wherein the analyzed transmitted stable information comprises an actual number of instances of transmission comma by the radio access network node to the user equipment, of the stable information.

16. The radio access network node of claim 13, wherein the stable information indicated by the stable information retrieval indication comprises information corresponding to a downlink traffic flow associated with a communication session between the user equipment and the radio access network node.

17. The radio access network node of claim 13, wherein the communication session between the user equipment and the radio access network node facilitates an extended reality (“XR”) service and wherein the downlink traffic flow corresponds to the XR service.

18. A non-transitory machine-readable medium, comprising executable instructions that, when executed by a processor of a radio access network node, facilitate performance of operations, comprising:
transmitting, to a user equipment, a stable information storage indication indicative to the user equipment to store, to a local storage associated with the user equipment, stable information associated with an XR environment corresponding to the user equipment;
receiving a downlink traffic payload indication indicative that the stable information is to be transmitted to the user equipment as downlink traffic payload of a downlink traffic flow associated with an XR communication session corresponding to the XR environment;
transmitting, to the user equipment, a stable information retrieval indication indicative to the user equipment to retrieve the stable information from the local storage; and
avoiding transmitting the stable information as downlink traffic payload corresponding to the downlink traffic flow.

19. The non-transitory machine-readable medium of claim 18, the operations further comprising:
transmitting, to the user equipment, a local storage flush indication indicative to the user equipment to remove the stable information from the local storage, wherein determining to transmit the local storage flush indication is facilitated by the radio access network node based on a size of the stable information and a local size, indicated in the local storage capability indication, corresponding to the local storage.

20. The non-transitory machine-readable medium of claim 18, the operations further comprising:
transmitting, to the user equipment, a local storage flush indication indicative to the user equipment to remove the stable information from the local storage, wherein determining to transmit the local storage flush indication is facilitated by the radio access network node based on an age of the stable information in the local storage.
